(19) United States
(12) Patent Application Publication
(10) Pub. No.: US 2016/0335830 A1
(43) Pub. Date: Nov. 17, 2016

(54) MEDIUM PROCESSING DEVICE AND MEDIUM TRANSACTION DEVICE

(71) Applicant: Oki Electric Industry Co., Ltd., Tokyo (JP)

(72) Inventors: Madoka Wakabayashi, Tokyo (JP); Kazuhiro Hosokawa, Tokyo (JP); Atsushi Takada, Tokyo (JP); Mamoru Kanbayashi, Tokyo (JP); Hajime Togiya, Tokyo (JP); Satoru Iwasaki, Tokyo (JP)

(73) Assignee: Oki Electric Industry Co., Ltd., Tokyo (JP)

(21) Appl. No.: 15/112,456

(22) PCT Filed: Jan. 7, 2015
(86) PCT No.: PCT/JP2015/050290

§ 371 Date: Jul. 19, 2016

(30) Foreign Application Priority Data
Mar. 31, 2014 (JP) 2014-073492
Oct. 28, 2014 (JP) 2014-219730

(51) Int. Cl. G07D 11/00; B65H 29/62; B65H 29/60

(52) U.S. Cl. CPC G07D 11/0084; B65H 29/60; B65H 29/62; B65H 2701/1912

(57) ABSTRACT

Present invention provides a medium processing device and a medium transaction device that may perform conveyance processing due to input and output of mediums with simple configuration. In a banknote deposit/withdrawal device of ATM, conveyance path inside a conveyance section is formed in straight line shape running mainly along front-rear direction. During deposit counting processing of deposit processing, the banknote deposit/withdrawal device retains deposit reject banknotes in a conveyance path retention section within a second conveyance section, and decides and stores conveyance destination for each banknote based on verification results obtained from a verification section, and during deposit storage processing of deposit processing, the banknote deposit/withdrawal device conveys banknotes fed out from a temporary holding section to the decided conveyance destinations to be stored. During withdrawal processing, the banknote deposit/withdrawal device decides banknote conveyance destinations based on detection results of a run sensor of the verification section.

### TECHNICAL FIELD

The present invention relates to a medium processing device and a medium transaction device suitable for application to, for example, an Automatic Teller Machine (ATM) that is input with a paper sheet shaped medium such as banknotes and performs desired transactions.

### BACKGROUND ART

Generally, ATMs employed in financial institutions and the like are configured to perform various transactions according to the contents of a transaction with a customer, for example deposit transactions in which a customer deposits cash such as banknotes or coins, or withdrawal transactions in which cash is withdrawn to the customer. One type of ATM is referred to as a re-cycling type (or recirculating type) in which banknotes deposited by a customer in one transaction are reused and withdrawn to another customer in a subsequent transaction.

Some re-cycling type ATMs are installed with a banknote deposit/withdrawal device that performs, for example, processing relating to banknote deposit and withdrawal. A proposal for such a banknote deposit/withdrawal device includes, for example, a deposit/withdrawal section that exchanges banknotes with a customer, a conveyance section that conveys banknotes, a verification section that verifies inserted banknotes by denomination and authenticity, a temporary holding section that temporarily holds inserted banknotes, banknote storage boxes that store banknotes by denomination, and a reject box that stores banknotes that are unsuitable for reuse (see, for example, Japanese Patent Application Laid-Open (JP-A) No. 2011-2912 (FIG. 3)).

For example, a conventional banknote deposit/withdrawal device 810 illustrated in FIG. 32 includes a deposit/withdrawal section 812, a conveyance section 813, a verification section 14, a temporary holding section 15, a reject box 16, and plural banknote storage boxes 17, as well as a banknote control section 811 that performs general overall control. The conveyance section 813 is provided with plural switching sections 821, 822, 823, and 824 and the like that switch a banknote conveyance destination under the control of the banknote control section 811 at respective locations where banknote conveyance paths intersect each other.

Deposit processing of the banknote deposit/withdrawal device 810 can be broadly split into deposit counting processing that is performed first, and deposit storage processing that is performed later. In the deposit counting processing, the banknote deposit/withdrawal device 810 takes in the banknotes deposited to the deposit/withdrawal section 812 one note at a time, uses the verification section 14 to verify each banknote en route as it is being conveyed by the conveyance section 813, conveys banknotes that can be accepted to the temporary holding section 15, and conveys banknotes that cannot be accepted to the deposit/withdrawal section 812 as deposit reject banknotes to be returned to the customer.

At this stage, the banknote deposit/withdrawal device 810 counts the deposited banknotes based on the verification results, displays the count result on a specific display section for the customer to confirm, and asks the customer whether or not to continue with the deposit processing. When deposit processing is continued, in the deposit storage processing, the banknote deposit/withdrawal device 810 feeds out the banknotes from the temporary holding section 15 one note at a time to be conveyed by the conveyance section 813, and re-verifies each banknote with the verification section 14. Banknotes suitable for reuse are conveyed to the banknote storage boxes 17 and stored, and banknotes unsuitable for reuse are conveyed to the reject box 16 and stored.

### SUMMARY OF INVENTION

### Technical Problem

In the conventional banknote deposit/withdrawal device 810 described above, the banknote conveyance destination is switched according to the verification results of the verification section 14 in both the deposit counting processing and the deposit storage processing. Accordingly, in the conventional banknote deposit/withdrawal device 810, it is necessary to form conveyance paths such that the banknotes pass the verification section 14 in both the deposit counting processing and the deposit storage processing, and also to provide respective switching sections to the conveyance section 13 at locations downstream of the verification section 14.

In order to complete the deposit processing in as short a time as possible, the banknote deposit/withdrawal device 810 conveys banknotes at as high a speed as possible in the conveyance section 813. However, in the banknote deposit/withdrawal device 810, a certain amount of time is needed between a banknote passing the verification section 14 and the banknote being able to pass the respective switching sections. Specifically, a certain amount of time is needed from the banknote control section 811 obtaining the results of the verification by the verification section 14 and deciding the conveyance destination of the banknote until completing conveyance destination switching operations in the respective switching sections.

Accordingly, in the banknote deposit/withdrawal device 810, it is necessary to provide a certain amount of distance between the verification section 14 and the respective switching sections, causing an increase in the conveyance distance of the banknotes. This results in an increase in the number of configuration components and greater complexity of the conveyance section 813 in the banknote deposit/withdrawal device 810, and also results in an increase in the size of the banknote deposit/withdrawal device 810 and the ATM to which it is installed.

The present invention provides a medium processing device and a medium transaction device that may performing conveyance processing due to input and output of a medium with a simple configuration.

### Solution to Problem

A first aspect of the present invention is a medium processing device including: an input/output section that inputs or outputs a paper sheet shaped medium; a first conveyance section, connected to the input/output section, that conveys the medium; a verification section, provided to the first conveyance section, that verifies the conveyed medium; a temporary holding switching section, connected to the first conveyance section at the opposite side from the input/output section and with the verification section thereinbetween, that switches a conveyance path of the medium; a temporary holding section, connected to the first conveyance section through the temporary holding switching section, that stores the medium temporarily, and that feeds out the medium in the same sequence or in a reverse sequence to when the medium was stored; a second conveyance section, connected to either the temporary holding section or the first conveyance section through the temporary holding switching section, that conveys the medium; a medium storage box, connected to the second conveyance section, that stores reusable medium; a reject box, connected to either the first conveyance section or the second conveyance section through a reject switching section, that stores any rejected medium that has been verified in the verification section as unsuitable for reuse; and a control section that employs a verification result of the verification section to control a conveyance path of the medium configured by the first conveyance section, the temporary holding switching section, and the second conveyance section.

A second aspect of the present invention is a medium transaction device including: an input/output section that inputs/outputs a paper sheet shaped medium for transaction with a user; a first conveyance section, connected to the input/output section, that conveys the medium; a verification section, provided to the first conveyance section, that verifies the conveyed medium; a storage section that stores a verification result of the verification section; a temporary holding switching section, connected to the first conveyance section at the opposite side from the input/output section and with the verification section thereinbetween, that switches a conveyance path of the medium; a temporary holding section, connected to the first conveyance section through the temporary holding switching section, that stores the medium temporarily, and that feeds out the medium in the same sequence or in a reverse sequence to when the medium was stored; a second conveyance section, connected to either the temporary holding section or the first conveyance section through the temporary holding switching section, that conveys the medium; a medium storage box, connected to the second conveyance section, that stores reusable medium; a reject box, connected to either the first conveyance section or the second conveyance section through a reject switching section, that stores any reject medium that has been verified in the verification section as unsuitable for reuse; and a control section that, during an acceptance transaction to accept the medium from a user through the input/output section, uses the first conveyance section to convey the medium from the input/output section to the temporary holding section through the verification section, and stores in the storage section a verification result by the verification section for the respective medium, and according to the verification result stored in the storage section for each of the medium, feeds the medium out from the temporary holding section and conveys the medium to either the medium storage box or to the reject box.

In the above aspects of the present invention, during deposit counting processing, medium taken in from the input/output section are stored in sequence in the temporary holding section, while undergoing verification by the verification section, after which, during deposit storage processing, the medium is fed out from the temporary holding section in the same sequence or in the reverse sequence to when being stored, and is conveyed to a conveyance destination based on the verification results obtained during the deposit counting processing. Accordingly, the above aspects of the present invention may enable appropriate storage in the medium storage box or the reject box without performing verification.

### Advantageous Effects of Invention

According to the above aspects, the present invention provides a medium processing device and a medium transaction device that may perform conveyance processing due to input and output of a medium with a simple configuration.

### BRIEF DESCRIPTION OF DRAWINGS

FIG. 1 is a schematic perspective view illustrating configuration of an ATM.

FIG. 2 is a schematic view illustrating configuration of a banknote deposit/withdrawal device according to a first exemplary embodiment.

FIG. 3A is a schematic view illustrating conveyance spacing and retention spacing between banknotes.

FIG. 3B is a schematic view illustrating conveyance spacing and retention spacing between banknotes.

FIG. 3C is a schematic view illustrating conveyance spacing and retention spacing between banknotes.

FIG. 4 is a schematic view illustrating configuration of a conveyance section according to the first exemplary embodiment.

FIG. 5 is a schematic view illustrating configuration of a temporary holding section.

FIG. 6 is a schematic view illustrating deposit counting processing.

FIG. 7 is a schematic view illustrating return of a deposit reject banknote.

FIG. 8 is a schematic view illustrating deposit storage processing.

FIG. 9 is a schematic view illustrating withdrawal processing

FIG. 10 is a schematic view illustrating switching of a conveyance destination based on a detection result of a run sensor.

FIG. 11A is a schematic view illustrating switching of a conveyance destination based on detection results of an image sensor and an authenticity sensor.

FIG. 11B is a schematic view illustrating switching of a conveyance destination based on detection results of an image sensor and an authenticity sensor.

FIG. 12 is a schematic view illustrating an outline of a banknote deposit/withdrawal device according to the first exemplary embodiment.

FIG. 13 is a schematic view illustrating deposit counting processing in the first exemplary embodiment.

FIG. 14 is a schematic view illustrating deposit storage processing in the first exemplary embodiment.

FIG. 15 is a schematic view illustrating withdrawal processing in the first exemplary embodiment.

FIG. 16 is a schematic view illustrating an outline of a conventional banknote deposit/withdrawal device.

FIG. 17 is a schematic view illustrating conventional deposit counting processing.

FIG. 18 is a schematic view illustrating conventional deposit storage processing.

FIG. 19 is a schematic view illustrating conventional withdrawal processing.

FIG. 20 is a schematic view illustrating configuration of a banknote deposit/withdrawal device according to a second exemplary embodiment.

FIG. 21 is a schematic view illustrating configuration of a banknote deposit/withdrawal device according to a third exemplary embodiment.

FIG. 22 is a schematic view illustrating configuration of a deposit/withdrawal section according to the third exemplary embodiment.

FIG. 23 is a schematic view illustrating configuration of a banknote deposit/withdrawal device according to a fourth exemplary embodiment.

FIG. 24 is a schematic view illustrating configuration of a banknote deposit/withdrawal device according to another exemplary embodiment.

FIG. 25 is a schematic view illustrating configuration of a banknote deposit/withdrawal device according to another exemplar) embodiment.

FIG. 26 is a schematic view illustrating configuration of a banknote deposit/withdrawal device according to another exemplary embodiment.

FIG. 27 is a schematic view illustrating configuration of a banknote deposit/withdrawal device according to another exemplary embodiment.

FIG. 28 is a schematic view illustrating configuration of a banknote deposit/withdrawal device according to another exemplary embodiment.

FIG. 29 is a schematic view illustrating configuration of a banknote deposit/withdrawal device according to another exemplary embodiment.

FIG. 30 is a schematic view illustrating configuration of a temporary holding switching section according to another exemplary embodiment.

FIG. 31A is a schematic view illustrating configuration of a temporary holding switching section according to another exemplary embodiment.

FIG. 31B is a schematic view illustrating configuration of a temporary holding switching section according to another exemplary embodiment.

FIG. 31C is a schematic view illustrating configuration of a temporary holding switching section according to another exemplary embodiment.

FIG. 32 is a schematic view illustrating configuration of a conventional banknote deposit/withdrawal device.

### DESCRIPTION OF EMBODIMENTS

Explanation follows regarding embodiments for implementing the present invention (referred to below as exemplary embodiments), with reference to the drawings.

### 1. First Exemplary Embodiment

### 1-1. Overall ATM Configuration

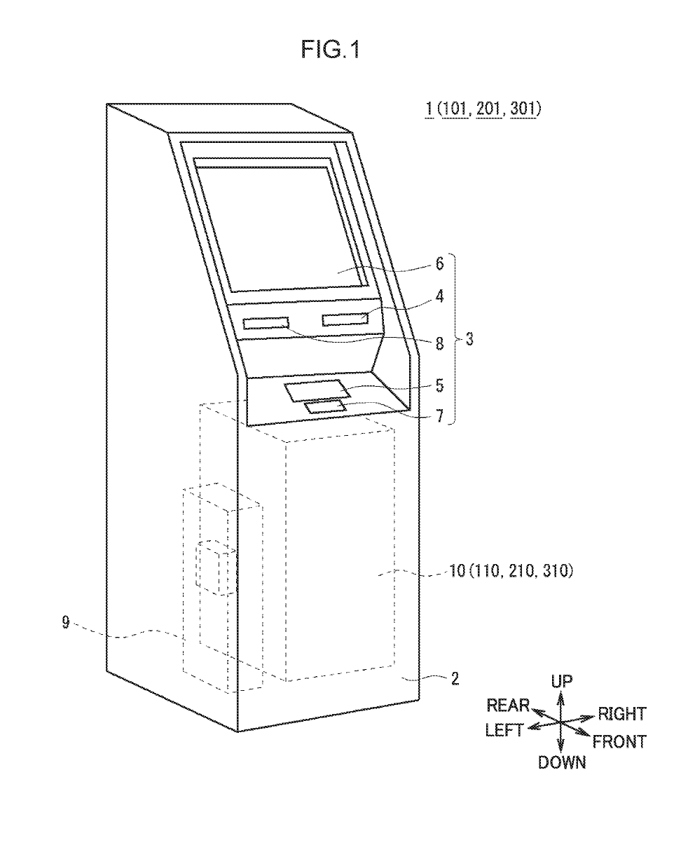

As illustrated in the external view of FIG. 1, an ATM 1 is configured around a box-shaped casing 2, and is, for example, installed in a financial institution and configured to perform cash transactions such as deposit processing and withdrawal processing with a customer.

The casing 2 is provided with a customer interface 3 at a location enabling easy banknote insertion, easy operation of a touch panel, and the like by a customer facing the front side of the casing 2. The customer interface 3, for example, directly handles cash and card transactions with the customer, and notifies information related to transaction and receives operation instructions. The customer interface 3 is provided with a card insertion/removal port 4, a deposit/withdrawal port 5, an operation and display section 6, a ten-key 7, and a receipt issue port 8.

The card insertion/removal port 4 is inserted with and returns various cards, such as cash cards. A card processor (not illustrated in the drawings) that reads, for example, account numbers magnetically recorded on the various cards is provided behind the card insertion/removal port 4. The deposit/withdrawal port 5 is inserted with banknotes deposited by a user, and dispenses banknotes BL for withdrawal to a user. The deposit/withdrawal port 5 is configured to open and close by driving a shutter. Note that banknotes are, for example, configured from rectangular shaped paper.

The operation and display section 6 is a touch panel integrated with a Liquid Crystal Display (LCD) that displays operation screens during transactions, and a touch sensor that is input with, for example, a transaction type selection, a PIN, or a transaction amount. The ten-key 7 is, for example, a physical keypad that is input with the numbers 0 to 9. The ten-key 7 is employed during PIN and transaction amount input operations and the like. The receipt issue port 8 issues a receipt printed with transaction details and the like at the end of transaction processing. A receipt processor (not illustrated in the drawings) that prints the transaction details and the like on the receipt is provided behind the receipt issue port 8.

In the following explanation, the front side is defined as the side of the ATM 1 facing a customer, and the opposite side thereto is defined as the rear side. The left side, right side, upper side and lower side are defined from the perspective of the left and right as seen by a customer facing the front side.

A main control section 9 that performs general control of the overall ATM 1, a banknote deposit/withdrawal device 10 that performs various processing relating to banknotes, and the like, are provided inside the casing 2. The main control section 9 is configured around a Central Processing Unit (CPU), not illustrated in the drawings. The main control section 9 reads and executes specific programs from ROM (not illustrated in the drawings), flash memory, or the like to perform various processing such as deposit processing and withdrawal processing. The main control section 9 is provided with an internal storage section including Random Access Memory (RAM), a hard disk drive, flash memory, or the like. The storage section is stored with various information.

### 1-2. Configuration of Banknote Deposit/Withdrawal Device

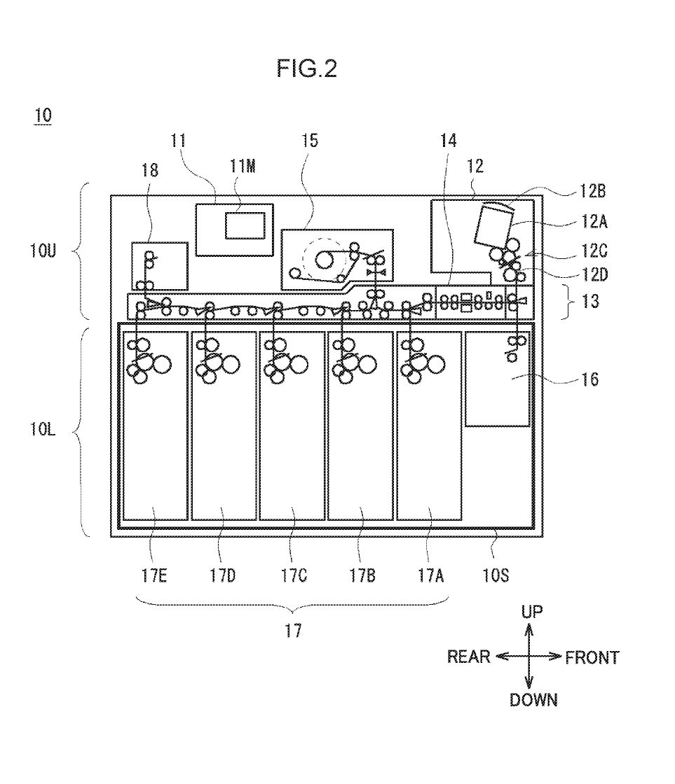

As illustrated in side view in FIG. 2, plural sections that perform various processing relating to banknotes, serving as a medium, are incorporated inside the banknote deposit/withdrawal device 10. The banknote deposit/withdrawal device 10 is configured split broadly into an upper section block 10U that takes up a portion further to the upper side than the approximate center in an up-down direction, and a lower section block 10L that closes up a portion at a lower side of the approximate center in an up-down direction.

1-2-1. Configuration of Upper Section Block

The upper section block 10U is provided with a banknote control section 11 that performs general overall control, a deposit/withdrawal section 12 that exchanges banknotes with a customer, a conveyance section 13 that conveys banknotes to the respective sections, a verification section 14 that verifies banknotes, a temporary holding section 15 that temporarily stores banknotes, and a counterfeit note box 18 that stores notes that have been verified as counterfeit notes.

Similarly to the main control section 9, the banknote control section 11, serving as a control section, is configured around a CPU (not illustrated in the drawings), and reads and executes specific programs from ROM (not illustrated in the drawings), flash memory, or the like to perform various processing such as processing to decide the conveyance destination of a banknote, and processing to control operation of the respective sections. The banknote control section 11 is provided with an internal storage section 11M including RAM, flash memory, or the like. The storage section 11M is stored with various information.

The deposit/withdrawal section 12, serving as an input/output section, is positioned at a front upper portion inside the upper section block 10U. The deposit/withdrawal section 12 includes an internal container 12A that contains banknotes paid in by a customer, and banknotes to be withdrawn to a customer. The deposit/withdrawal section 12 can be opened and closed by a shutter 12B above the deposit/withdrawal section 12. Plural banknotes are stacked inside the container 12A in a state with their sheet faces facing the front-rear direction, namely contained in a state arranged in a line along the front-rear direction.

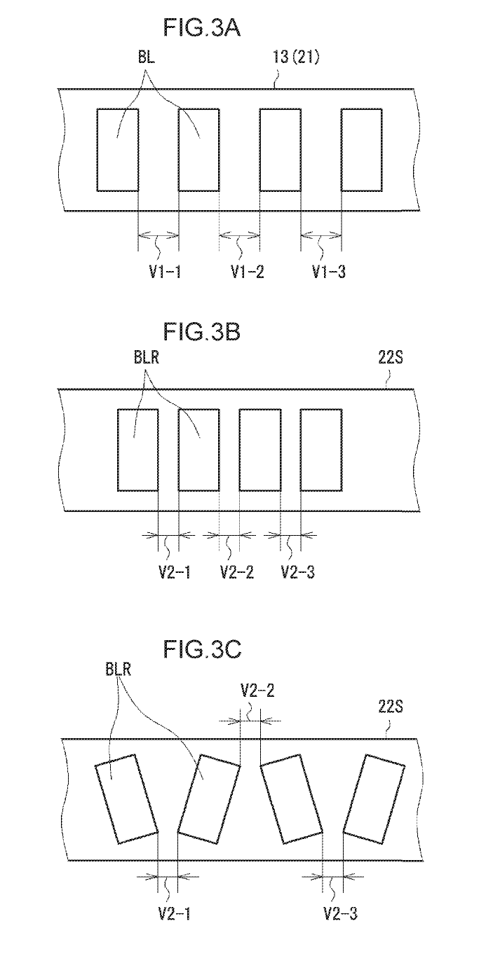

A take-in/discharge port 12C and a deposit/withdrawal conveyance section 12D are provided at the lower front of the deposit/withdrawal section 12. Under the control of the banknote control section 11, the take-in/discharge port 12C switches operation between two operation modes, namely a take-in mode and a discharge mode. Namely, in the take-in mode, the take-in/discharge port 12C separates banknotes inside the container 12A one note at a time to be sent out downward at a specific time interval, and passes the banknotes to the conveyance section 13 using the deposit-withdrawal conveyance section 12D. The conveyance section 13 thereby conveys banknotes BL with a specific conveyance spacing V1 between the banknotes, as illustrated in FIG. 3A (the conveyance spacings V1-1, V1-2, and V1-3 in FIG. 3A). In the discharge mode, the take-in/discharge port 12C discharges banknotes passed from the conveyance section 13 by the deposit/withdrawal conveyance section 12D into the container 12A.

The counterfeit note box 18, serving as a counterfeit medium box, is provided at a position directly above and adjacent to the conveyance section 13, in the vicinity of a rear end inside the upper section block 10U. A space to store banknotes is provided inside the counterfeit note box 18. The counterfeit note box 18 internally stores banknotes conveyed by the conveyance section 13 that have been determined to be counterfeit banknotes (referred to below as counterfeit notes) by the verification section 14 and the banknote control section 11, described later.

1-2-2. Configuration of Conveyance Section

The conveyance section 13 is disposed at a lower end portion inside the upper section block 10U, in other words, above the lower section block 10L, described later. Namely, the conveyance section 13 is positioned so as to cut across in the front-rear direction substantially at the up-down direction center of the overall banknote deposit/withdrawal device 10, and has an overall shape that is thin in the up-down direction, and long and thin in the front-rear direction. Several rotating rollers, guides that guide the banknotes, and the like are disposed as appropriate inside the conveyance section 13, thereby forming a straight line shaped conveyance path that conveys banknotes substantially along the front-rear direction with the short edge direction as the direction of progress.

Plural switching sections are disposed inside the conveyance section 13. Each switching section is configured by a member referred to as a “blade” (illustrated by triangular shapes in the drawings), and plural rollers disposed around the blade. The blades are long in the left-right direction, and are formed in wedge shapes as viewed along the left-right direction. The blades rotate to change their inclination direction, thereby switching between two banknote conveyance directions. The respective rollers are disposed facing each other across a banknote conveyance path. Under the control of the banknote control section 11, the switching sections change the inclination directions of their respective blades and rotate the respective rollers in specific rotation directions according to the conveyance destination of each banknote, thereby appropriately switching the banknote conveyance direction so as to convey toward the desired conveyance destination.

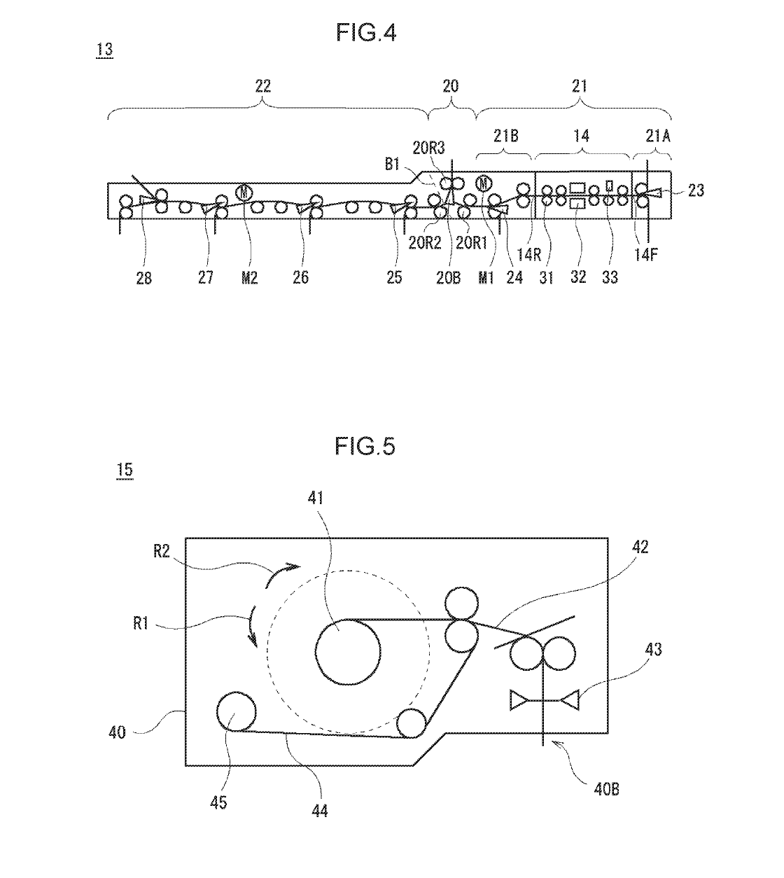

As illustrated in enlarged view in FIG. 4, the conveyance section 13 is configured broadly split into a first conveyance section 21 on the front side, a second conveyance section 22 on the rear side, and a temporary holding switching section 20 connecting the two together.

The temporary holding switching section 20 is configured by a centrally positioned blade 20B, and rollers 20R1, 20R2, and 20R3 respectively positioned at the front side, the rear side, and the upper side of the blade 20B. Similarly to the blades of the respective switching sections described above, the blade 20B rotates to change its angle of inclination. However, unlike the other switching sections, the blade 20B switches the banknote conveyance direction three ways, and is what is referred to as a three-way blade.

Specifically, the temporary holding switching section 20 switches between forming a conveyance path linking the temporary holding section 15 at the upper side to the first conveyance section 21 at the front side, forming a conveyance path linking the temporary holding section 15 at the upper side to the second conveyance section 22 at the rear side, or forming a conveyance path linking the first conveyance section 21 at the front side to the second conveyance section 22 at the rear side.

In sequence from the front, a reject switching section 23, the verification section 14 (described in detail later), and a first switching section 24 are disposed in series inside the first conveyance section 21. These sections are connected together by short conveyance paths that are relatively short. Accordingly, a straight line shaped conveyance path is formed along the front-rear direction overall inside the first conveyance section 21. For ease of explanation, the respective parts of the first conveyance section 21 to the front side and the rear side of the verification section 14 are referred to as the front part 21A and the rear part 21B.

The reject switching section 23 changes the blade inclination direction to switch the banknote conveyance path two ways. The reject switching section 23 either forms a conveyance path linking the deposit/withdrawal section 12 at the upper side and the verification section 14 at the rear side, or forms a conveyance path linking the verification section 14 at the rear side to a reject box 16 at the lower side. The first switching section 24 switches the banknote conveyance path two ways similarly to the reject switching section 23, and either forms a conveyance path linking a short conveyance path at the rear side to a banknote storage box 17A at the lower side, or forms a conveyance path linking the short conveyance path at the rear side to a short conveyance path at the front side.

In sequence from the front, a second switching section 25, a third switching section 26, a fourth switching section 27, and a counterfeit note switching section 28 are disposed in series inside the second conveyance section 22. Similarly to in the first conveyance section 21, these sections are respectively connected together by short conveyance paths that are relatively short, thereby forming a straight line shaped conveyance path along the front-rear direction overall.

The second switching section 25, the third switching section 26, and the fourth switching section 27 are each formed with substantially front-rear symmetry to the first switching section 24, and are each configured so as to switch the banknote conveyance path two ways. Namely, the second switching section 25, the third switching section 26, and the fourth switching section 27 switch between forming conveyance paths linking respective short conveyance paths on the front side to respective banknote storage boxes 17B, 17C, or 17D on the lower side, or forming conveyance paths linking the respective short conveyance paths on the front side with short conveyance paths on the rear side.

The counterfeit note switching section 28 is formed with substantially up-down symmetry to the second switching section 25, the third switching section 26, and the fourth switching section 27, and switches between forming a conveyance path linking a short conveyance path on the front side with the counterfeit note box 18 on the upper side, and forming a conveyance path linking the short conveyance path on the front side with a banknote storage box 17E through a short conveyance path on the rear side.

Note that drive force is transmitted to each of the rollers of the first conveyance section 21 and the second conveyance section 22, and each of the rollers configuring the temporary holding switching section 20, from dedicated motors M1 and M2 that are controlled independently of each other in respective regions separated from front to rear about a drive boundary line B1, illustrated in FIG. 4.

Namely, the motor M1 on the front side drives each of the rollers of the first conveyance section 21, and the roller 20R1 of the temporary holding switching section 20 positioned on the front side of the blade 20B. The motor M2 on the rear side drives each of the rollers of the second conveyance section 22, and the roller 20R2 of the temporary holding switching section 20 positioned on the rear side of the blade 20B. Note that the roller 20R3 of the temporary holding switching section 20 rotates by receiving drive power supplied from the temporary holding section 15, described later.

Accordingly, in the conveyance section 13, the motors M1 and M2 are each independently controlled by the banknote control section 11, and portions further to the front side than the blade 20B of the temporary holding switching section 20 (namely, mainly the respective rollers of the first conveyance section 21) and portions further to the rear side than the blade 20B of the temporary holding switching section 20 (namely, mainly the respective rollers of the second conveyance section 22) are driven independently of each other, and are capable of conveying banknotes independently of each other.

The motors M1 and M2 have configurations enabling fine rotation angle control by the banknote control section 11, such as those of stepping motors or Direct Current (DC) brushless motors. The banknote control section 11 thereby ascertains accurate rotation rates, rotation angles, and the like for the motor M1 and the motor M2. By performing arithmetic processing such as multiplying the rotation rates and rotation angles of the motor M1 and the motor M2 by specific coefficients, the banknote control section 11 also ascertains the rotation rates and rotation angles of the respective rollers, namely the conveyance distances of banknotes.

Accordingly, in the conveyance section 13, a straight line shaped conveyance path is formed along the front-rear direction by the first conveyance section 21, the temporary holding switching section 20, and the second conveyance section 22, and the conveyance section 13 is configured such that banknotes are conveyed along the conveyance path mainly in the front-rear direction, and the conveyance path is switched by the plural switching sections.

1-2-3. Configuration of Verification Section

Plural types of sensor are incorporated inside the verification section 14 to identify the denomination, authenticity, condition (whether or not damage is present), and conveyance states of conveyed banknotes. The identification results are sent to the banknote control section 11. Note that conveyance states indicate states such as, for example, whether or not a banknote is at an angle with respect to the conveyance direction, whether or not the spacing between conveyed banknotes is appropriate, and whether or not plural banknotes are overlapping (namely, whether or not overlapping conveyance or strings of touching banknotes have occurred).

Specifically, inside the verification section 14, a conveyance path is formed linking a front exchange port 14F on a front side and a rear exchange port 14R on a rear side in a straight line shape along the front-rear direction. A run sensor 31, an image sensor 32, and an authenticity sensor 33 are disposed in sequence from the rear side along this conveyance path.

The run sensor 31 includes, for example, a thickness sensor and optical sensors. The thickness sensor detects the thickness of a conveyed banknote, and supplies a detection result to the banknote control section 11. Based on the detection result supplied from the thickness sensor, the banknote control section 11 determines whether the thickness of the conveyed banknote corresponds to that of a single banknote, or corresponds to that of two or more banknotes.

In each of the optical sensors, a light emitting element that emits light, and a light receiving element that receives the light, are, for example, disposed facing each other across the conveyance path. The optical sensors detect whether or not light is being blocked by a banknote conveyed on the conveyance path, and send detection results to the banknote control section 11. In the run sensor 31, plural of the optical sensors are disposed along the left-right direction, namely along a direction intersecting the front-rear direction, this being the conveyance direction. Based on the detection results supplied from the respective optical sensors and their changes over time and the like, the banknote control section 11 identifies the lengths of banknotes being conveyed along the conveyance direction, the spacing between banknotes along the conveyance direction, and the angles of banknotes with respect to the conveyance direction.

Namely, the run sensor 31 supplies the respective detection results of the thickness sensor and the optical sensors to the banknote control section 11. The banknote control section 11 thereby identifies banknote conveyance states such as the spacing between banknotes, whether or not banknotes are at an angle (referred to as skew), and whether or not banknotes are overlapping (referred to as overlapping conveyance or strings of touching banknotes).

The image sensor 32 includes two imaging elements facing each other across the conveyance path. The imaging elements image the two faces of banknotes conveyed on the conveyance path to generate image data, and send the image data to the banknote control section 11. The banknote control section 11 compares pre-stored image data for each denomination against the supplied image data to identify the denomination, level of damage, and the like of each banknote, and also to identify the individual serial number inscribed on each banknote.

The authenticity sensor 33 is, for example, a magnetic sensor, and detects the magnetism of banknotes conveyed on the conveyance path, and sends a detection result to the banknote control section 11. Based on the detection result supplied from the authenticity sensor 33, the banknote control section 11 determines whether a banknote is genuine (what is referred to as a genuine note) or counterfeit (what is referred to as a counterfeit note).

The verification section 14 is installed inside the first conveyance section 21 at a very short distance from the reject switching section 23. Specifically, the distance between the authenticity sensor 33 positioned furthest to the front inside the verification section 14 and a rear end of the blade of the reject switching section 23 positioned in front of the authenticity sensor 33 is shorter than the length of a banknote along the conveyance direction, namely shorter than the length of a short edge of a banknote.

Accordingly, in the first conveyance section 21, for example when a banknote is being conveyed from the rear toward the front inside the verification section 14, a leading edge of the banknote reaches the blade of the reject switching section 23 before a terminal portion of the banknote reaches the authenticity sensor 33 for magnetism detection.

1-2-4. Configuration of Temporary Holding Section

The temporary holding section 15 employs what is referred to as a tape escrow method, and stores banknotes by wrapping the banknotes against a circumferential side face of a circular cylinder shaped drum together with a tape, and feeds out the banknotes by peeling the tape away from the circumferential side face. Specifically, as illustrated in enlarged view in FIG. 5, the temporary holding section 15 includes a drum 41, a temporary holding conveyance section 42, a run monitoring sensor 43, a tape 44, a reel 45, and the like inside a substantially rectangular block shaped casing 40.

The drum 41 is formed in a circular cylinder shape with its axial center along the left-right direction, and is supported so as to be capable of rotation substantially at the center inside the casing 40. Drive power is transmitted to the drum 41 from a motor (not illustrated in the drawings) controlled by the banknote control section 11, thereby rotating the drum 41 in a take-up direction R1 or in an unwinding direction R2.

The motor is configured by, for example, a stepping motor or a DC brushless motor, similarly to the respective motors that drive the first conveyance section 21 and the second conveyance section 22. The banknote control section 11 thereby ascertains an accurate rotation angle of the motor, and performs arithmetic processing such as multiplying the rotation angle by specific coefficients to ascertain the rotation rate and rotation angle of the drum 41, as well as a wrapping distance (namely length) of the tape 44 around the circumferential side face.

The temporary holding conveyance section 42 is configured by plural rollers, guides, and the like, and conveys banknotes in both directions between an exchange port 40B formed toward the front of a lower face of the casing 40, and the circumferential side face of the drum 41. The run monitoring sensor 43, serving as a temporary holding detection section, is disposed in the vicinity of the exchange port 40B in the temporary holding conveyance section 42. The run monitoring sensor 43 has a similar configuration to the optical sensors provided to the run sensor 31 of the verification section 14, and detects banknote conveyance states and sends detection results to the banknote control section 11. In response, the banknote control section 11 identifies the spacing between the banknotes conveyed by the temporary holding conveyance section 42, identifies the presence of skew, and identifies banknote overlap and conveyance direction lengths.

The tape 44 is formed in a long, narrow thin film shape, and is taken up onto a circumferential side face of the reel 45 that is formed in a bobbin shape. The tape 44 is pulled out from the reel 45 and laid out so as to run around the inside of the casing in an appropriate manner, before contacting the circumferential side face of the drum 41 along the temporary holding conveyance section 42, and ultimately being wrapped around the circumferential side face of the drum 41.

In the temporary holding section 15 configured in this manner, when storage processing is performed to store banknotes passed in sequence from the conveyance section 13, the temporary holding conveyance section 42 conveys each banknote upward and toward the rear, and rotates the drum 41 in the take-up direction R1, thereby wrapping the banknotes around the circumferential side face of the drum 41 together with the tape 44.

When this is performed, the temporary holding section 15 aligns the banknote conveyance speed of the temporary holding conveyance section 42 with that of the conveyance section 13, and adjusts the rotation speed of the drum 41 so as to align the running speed of the tape 44 and the linear speed of an outermost peripheral portion of the drum 41 with the banknote conveyance speed. Accordingly, the temporary holding section 15 wraps respective banknotes onto the circumferential side face of the drum 41 together with the tape 44 to be stored, while preserving the skew of banknotes conveyed in sequence from the conveyance section 13 with respect to the conveyance direction, and the spacing between the banknotes, namely preserving the conveyance state of the banknotes.

When the temporary holding section 15 performs feed-out processing to feed out banknotes to the conveyance section 13 in sequence, the reel 45 is rotated in a specific direction to take up the tape 44, and the drum 41 is rotated in the unwinding direction R2, such that the banknotes wrapped around the drum 41 are peeled off together with the tape 44 and passed to the temporary holding conveyance section 42. The temporary holding conveyance section 42 conveys the banknotes toward the front and downward, and passes the banknotes to the conveyance section 13 through the exchange port 40B.

When this is performed, the temporary holding section 15 aligns the banknote conveyance speed of the temporary holding conveyance section 42 with that of the conveyance section 13, and also aligns the running speed of the tape 44 and the linear speed of the outermost peripheral portion of the drum 41 with the banknote conveyance speed. Accordingly, the temporary holding section 15 is able to feed out the respective banknotes in sequence, this being the opposite sequence to when storing the banknotes, and pass the banknotes to the conveyance section 13, while preserving the conveyance state of the banknotes as it was when the banknotes were wrapped around the circumferential side face of the drum 41, namely preserving the skew of the banknotes with respect to the conveyance direction and the spacing between the banknotes.

In this manner, the temporary holding section 15 is configured to wrap banknotes onto the circumferential side face of the drum 41 together with the tape 44, and unwind to peel the banknotes off, thereby storing or feeding out the banknotes with their conveyance state preserved.

1-2-5. Configuration of Lower Section Block

The lower section block 10L is provided with the reject box 16 that stores banknotes that are unsuitable for re-use, and the five banknote storage boxes 17 (17A, 17B, 17C, 17D, and 17E) that store banknotes that can be re-used.

The reject box 16 is positioned furthest to the front side and toward the top inside the lower section block 10L, is formed in a rectangular block shape that is long in the up-down direction, and includes an internal space in which banknotes are stacked and stored. Note that the length of the reject box 16 in the up-down direction is approximately half that of the lower section block 10L. Banknotes that the verification section 14 and the banknote control section 11 have determined to have a high level of damage and to be unsuitable for re-use are conveyed by the conveyance section 13 and internally stored in the reject box 16.

Behind the reject box 16 inside the lower section block 10L, the banknote storage boxes 17A, 17B, 17C, 17D, and 17E, serving as medium storage boxes, are provided in sequence from the front side toward the rear side. Each of the banknote storage boxes 17 (17A, 17B, 17C, 17D, and 17E) is of similar configuration, and is formed in a rectangular block shape that is long in the up-down direction, and includes an internal space in which banknotes are stacked and stored. Note that the length of each banknote storage box 17 in the up-down direction is substantially the same as that of the lower section block 10L.

Each of the banknote storage boxes 17 is preset with a banknote denomination to be stored therein. Banknotes that the verification section 14 and the banknote control section 11 have determined to have a low level of damage and to be suitable for re-use are conveyed by the conveyance section 13 and internally stacked and stored in the banknote storage boxes 17 by denomination. On receipt of an instruction from the banknote control section 11 to feed out banknotes, the banknote storage boxes 17 separate and feed out the stacked banknotes one note at a time to be passed to the conveyance section 13.

Note that, depending on the control of the banknote control section 11, the banknote storage boxes 17 may also operate as withdrawal boxes that only feed out stored banknotes, and of operating as deposit boxes that only store conveyed banknotes.

Every peripheral side face of the lower section block 10L is covered by a safe casing 10S, serving as a sturdy heavy-duty casing. The safe casing 10S is, for example, provided with an openable and closable door at a rear side, and a lock that maintains a closed state (neither of which are illustrated in the drawings). The respective sections inside the lower section block 10L can only be accessed when the lock has been unlocked and the door has been opened.

The conveyance section 13 is positioned above the lower section block 10L, namely outside the safe casing 10S. The first conveyance section 21, the temporary holding switching section 20, and the second conveyance section 22 of the conveyance section 13 are thus in a row from front to rear at the upper side of the safe casing 10S, and form a straight line shaped conveyance path along the front-rear direction. An upper face of the safe casing 10S is provided with long thin slit shaped through holes between the conveyance section 13 and the reject box 16 or the respective banknote storage boxes 17. The conveyance section 13 is capable of exchanging banknotes with the reject box 16 and the respective banknote storage boxes 17 in the up-down direction through the through holes of the safe casing 10S.

Note that each of the banknote storage boxes 17 is also referred to as a banknote storage cassette, and is configured so as to be attachable and detachable with respect to the lower section block 10L, serving as a loading block. Specifically, the lower section block 10L is incorporated with a slide mechanism (not illustrated in the drawings) that enables an internal frame (not illustrated in the drawings) to slide in the front-rear direction with respect to the safe casing 10S, and the frame is formed with plural slots (not illustrated in the drawings) along the front-rear direction, this being an arrangement direction. Similarly, the reject box 16 is also referred to as a reject cassette, and, similarly to the banknote storage boxes 17, is configured so as to be attachable and detachable with respect to the lower section block 10L. The banknote storage boxes 17 and the reject box 16 have mutually interchangeable structures.

The respective banknote storage boxes 17 are pulled out from the slots, or loaded into the slots, in a state in which the frame has been pulled out from the safe casing 10S of the lower section block 10L. When the banknote storage boxes 17 have been removed from the slots, a member of staff of the financial institution removes banknotes stored inside the banknote storage boxes 17, or stores banknotes. Banknotes that are stored at this time are banknotes that have been verified by denomination, authenticity, level of damage, and the like by a specific banknote processing device or the like, and are in a good quality state that can be withdrawn by a customer during withdrawal processing.

### 1-3. Deposit Processing and Withdrawal Processing

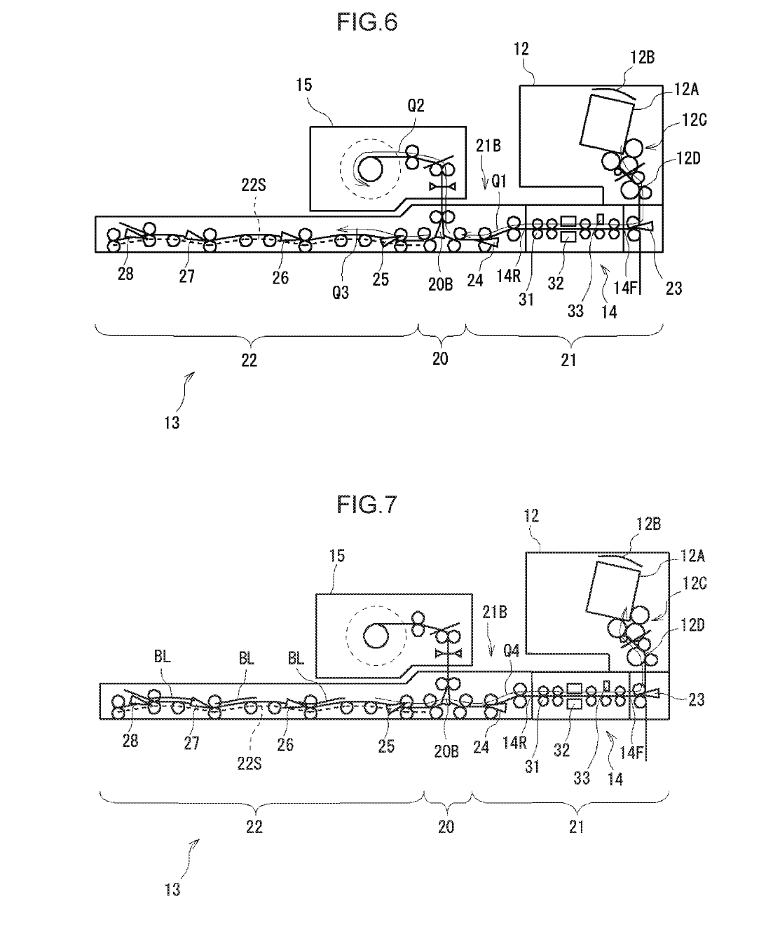

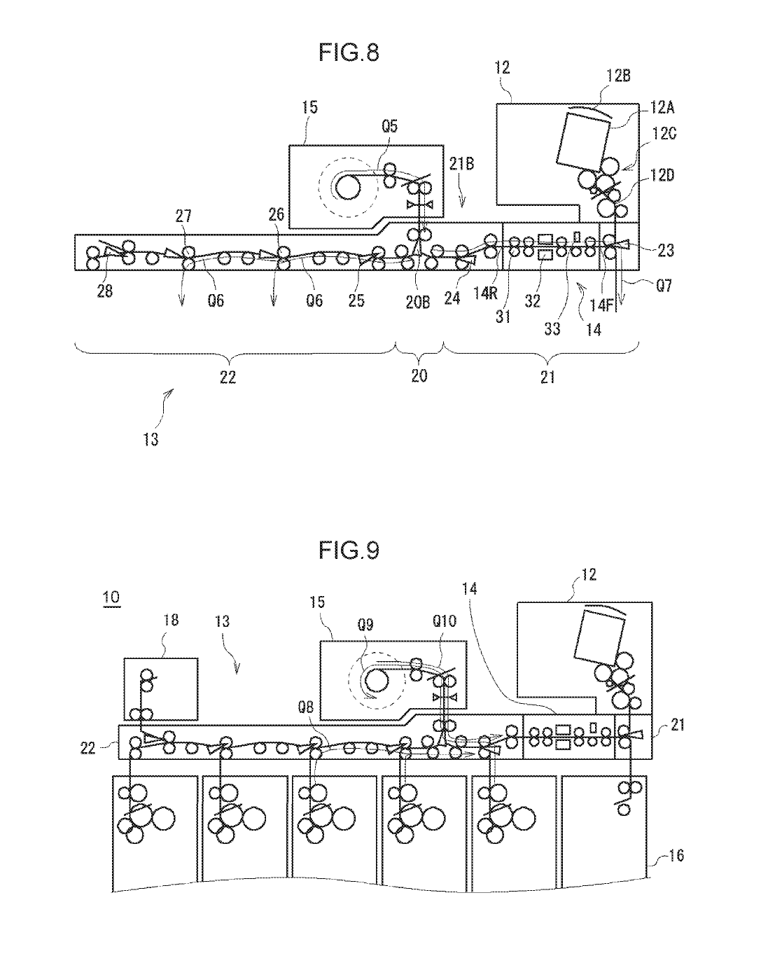

Next, detailed explanation follows regarding deposit processing and withdrawal processing of the banknote deposit/withdrawal device 10 respectively, with reference to FIG. 6, FIG. 7, and FIG. 8. Note that FIG. 6. FIG. 7, and FIG. 8 each illustrate enlargements of the deposit/withdrawal section 12, the conveyance section 13, the verification section 14, and the temporary holding section 15 of the upper section block 10U of the banknote deposit/withdrawal device 10.

1-3-1. Deposit Processing

First, explanation follows regarding deposit processing performed when a customer (user) deposits banknotes in the ATM 1, with reference to FIG. 6 and FIG. 7. In deposit processing, serving as acceptance processing, under control of the banknote control section 11, the banknote deposit/withdrawal device 10 first performs deposit counting processing to count the number of deposited banknotes while verifying the banknotes by denomination and the like, before performing deposit storage processing to convey the banknotes to an appropriate storage location to be stored.

Specifically, for example, the banknote control section 11 receives input of an operation by a customer to start deposit processing through the operation and display section 6 (FIG. 1), and then starts the deposit counting processing, and opens the shutter 12B of the deposit/withdrawal section 12 to allow banknotes to be inserted into the container 12A. Next, on receipt of input of an operation to start taking in the banknotes through the operation and display section 6, the banknote control section 11 closes the shutter 12B and operates the take-in/discharge port 12C in the take-in mode, thereby separating and taking in the banknotes in the container 12A one note at a time, and passing the banknotes in sequence to the first conveyance section 21 of the conveyance section 13 positioned downstream.

Note that the take-in/discharge port 12C passes the banknotes to the first conveyance section 21 of the conveyance section 13 positioned downstream in a state in which the short edges of the banknotes are substantially parallel with the conveyance direction, and the long edges are substantially orthogonal to the conveyance direction. As illustrated in FIG. 3A, the take-in/discharge port 12C takes in and feeds out the banknotes at the specific time interval so as to space the banknotes conveyed by the first conveyance section 21 at the specific conveyance spacing V1.

The first conveyance section 21 switches the reject switching section 23 to form a conveyance path linking the deposit/withdrawal section 12 and the verification section 14 on the rear side, and, as illustrated by the arrow Q1 (FIG. 6), the banknotes are passed in sequence downstream to the front exchange port 14F on the front side of the verification section 14.

The verification section 14 verifies each of the banknotes in sequence using the authenticity sensor 33, the image sensor 32, and the run sensor 31 while internally conveying the banknotes toward the rear, and passes the banknotes again, this time to the rear part 21B of the first conveyance section 21 through the rear exchange port 14R on the rear side. The verification section 14 also sends the detection results to the banknote control section 11. Note that each sensor of the verification section 14 is capable of verifying the banknotes BL one note at a time, while clearly identifying the boundaries between the banknotes BL, since the banknotes BL conveyed in sequence are spaced out at the relatively wide conveyance spacing V1.

Based on the acquired detection results, the banknote control section 11 first determines the level of damage, denomination, and authenticity of each banknote. Next, the banknote control section 11 determines whether each banknote is a deposit acceptable banknote that can be identified as a normal banknote and can go on to subsequent processing, or a deposit reject banknote that cannot be identified as a normal banknote and should therefore be returned to the user. Deposit reject banknotes are often determined, for example, when banknotes are in a folded state, when banknotes are heavily creased, or when a piece of paper other than a banknote (such as notepaper or a receipt) has been accidentally inserted into the deposit/withdrawal section 12.

The banknote control section 11 decides a final conveyance destination for deposit acceptable banknotes, namely the reject box 16 for reject banknotes with a high level of damage, the banknote storage box 17 of the respective denomination for normal, reusable banknotes, and the counterfeit note box 18 for counterfeit notes. The banknote control section 11 moreover associates the denomination, serial number, conveyance state (namely skew and the spacing between the banknotes), and the decided conveyance destination and the like of each banknote with the banknote conveyance sequence, and stores this in the storage section 11M as information during counting by the verification section 14.

Next, the first conveyance section 21 uses the first switching section 24 to form a conveyance path linking the short conveyance path at the rear side to the short conveyance path at the front side, and uses the rear part 21B to convey the banknotes received from the rear exchange port 14R of the verification section 14 positioned upstream toward the rear, and passes the banknotes in sequence to the temporary holding switching section 20 positioned downstream of the verification section 14.

Under control of the banknote control section 11, the temporary holding switching section 20 switches the conveyance path according to the verification results for each banknote. Specifically, for deposit acceptable banknotes and counterfeit notes, as illustrated by the arrow Q2, the temporary holding switching section 20 forms a conveyance path linking the temporary holding section 15 at the upper side to the first conveyance section 21 at the front side, and transports the banknotes to the temporary holding section 15. For deposit reject banknotes, as illustrated by the arrow Q3, the temporary holding switching section 20 forms a conveyance path linking the first conveyance section 21 at the front side and the second conveyance section 22 at the rear side, and transports the banknotes into the second conveyance section 22.

The temporary holding section 15 performs the storage processing described above to sequentially store the deposit acceptable banknotes and counterfeit notes received in sequence from the upstream temporary holding switching section 20. When this is performed, the temporary holding section 15 uses the temporary holding conveyance section 42 (FIG. 5) to convey the banknotes at the same conveyance speed as that of the first conveyance section 21, and runs the tape 44 and rotates the drum 41 such that the circumferential side face has an equivalent linear speed thereto. The temporary holding section 15 thereby wraps the respective banknotes on in sequence, while preserving the conveyance state of the banknotes on the first conveyance section 21, namely the angle of each banknote with respect to the conveyance direction, the front-rear spacing between the banknotes, and the like.

When this is performed, the temporary holding section 15 detects the conveyance state of each banknote using the run monitoring sensor 43, and sends the detection results to the banknote control section 11. In response, the banknote control section 11 associates the detection results with the banknote conveyance sequence, and stores this in the storage section 11M as conveyance information during storage in the temporary holding section 15.

The second conveyance section 22 retains deposit reject banknotes received from the upstream temporary holding switching section 20 in sequence in the conveyance path along the front-rear direction (referred to below as the conveyance path retention section 22S), as illustrated by the intermittent line portion in FIG. 7. In other words, although the main function of the second conveyance section 22 is as a conveyance path that conveys banknotes mainly in the front-rear direction, the second conveyance section 22 also functions as a conveyance path retention section 22S that retains banknotes BL during the deposit counting processing.

Specifically, when a deposit reject banknote is conveyed from the temporary holding switching section 20 at the same conveyance speed as the first conveyance section 21 upstream, the second conveyance section 22 rotates the respective rollers and the like by a conveyance amount corresponding to one banknote plus a small gap, and then immediately stops the rollers. The second conveyance section 22 repeats this operation each time a deposit reject banknote arises, so as to retain the deposit reject banknotes BLR in the conveyance path retention section 22S while reducing the spacing between the deposit reject banknotes BLR from the conveyance spacing V1 to a specific retention spacing V2 (V2-1, V2-2, and V2-3), as illustrated in FIG. 3B. Namely, the second conveyance section 22 intermittently conveys deposit reject banknotes to the conveyance path retention section 22S to be retained every time a deposit reject banknote is conveyed.

In other words, the banknote control section 11 uses the motor M1 (FIG. 4) to continuously rotate the respective rollers of the first conveyance section 21 and continuously convey banknotes, and uses the motor M2 to intermittently or non-continuously drive the respective rollers of the second conveyance section 22, thereby alternating repeatedly between conveying and stopping banknotes (deposit reject banknotes) so as to convey the banknotes intermittently or non-continuously. When this is performed, as illustrated in FIG. 3C, for example, the banknote control section 11 is capable of aligning the spacing between the deposit reject banknotes BLR with the retention spacing V2, even when the short edges of deposit reject banknotes BLR are in an angled state with respect to the conveyance direction (what is referred to as skew), and the deposit reject banknotes BLR take up a longer range along the conveyance direction than if the deposit reject banknotes BLR were not skewed.

Note that in the second conveyance section 22, error may arise between the control of the motor M2 by the banknote control section 11 and the actual rotation angles of the respective rollers and the like. Accordingly, in the conveyance path retention section 22S, the retention spacing V2-1, V2-2, and V2-3 are not necessarily the same lengths as each other, and sometimes a certain amount of error arises. On average, however, the conveyance path retention section 22S is capable of reducing the retention spacing V2 compared to the conveyance spacing V1.

The banknote control section 11 also ascertains the position of a rear edge of a first deposit reject banknote based on control signals or the like to the motor M2 (FIG. 4) that drives the respective rollers of the second conveyance section 22. Accordingly, when the rear edge reaches a rear end of the conveyance path retention section 22S, the banknote control section 11 determines that a state in which deposit reject banknotes are being retained at all possible retention locations inside the conveyance path retention section 22S, namely a full state, has arisen, and no new deposit reject banknotes can be retained.

In such cases, the banknote control section 11 first temporarily interrupts the deposit counting processing and pauses conveyance of banknotes from the deposit/withdrawal section 12 toward the rear. Next, as illustrated by the arrow Q4 in FIG. 7, the banknote control section 11 conveys all of the deposit reject banknotes retained inside the conveyance path retention section 22S in sequence toward the front using the temporary holding switching section 20, the first conveyance section 21, and the verification section 14. Namely, the banknote control section 11 conveys the deposit reject banknotes back in the opposite direction to that during the deposit counting processing, to return the deposit reject banknotes into the deposit/withdrawal section 12. Moreover, the banknote control section 11 opens the shutter 12B and displays a specific message on the operation and display section 6 to prompt the customer to check the state of the banknotes and reinsert the banknotes inside the container 12A. The banknote control section 11 then resumes the deposit counting processing.

Finally, when the banknote control section 11 has finished taking in all of the banknotes from the container 12A of the deposit/withdrawal section 12, if any deposit reject banknotes are retained in the conveyance path retention section 22S, these are conveyed to the deposit/withdrawal section 12 (namely conveyed back in the opposite direction) and returned to the customer, who then confirms and reinserts the banknotes. If there are no deposit reject banknotes retained in the conveyance path retention section 22S, the banknote control section 11 ends the deposit counting processing.

When this is performed, the banknote control section 11 calculates a deposit amount based on a summed result of the denominations and number of notes of the banknotes taken in from the deposit/withdrawal section 12, and displays a specific operation instruction screen on the operation and display section 6, shows the customer the deposit amount, and prompts the customer to select whether or not to continue with the deposit processing.

Note that if the customer instructs the banknote control section 11 to abandon the deposit processing, the banknote control section 11 uses the temporary holding switching section 20, the first conveyance section 21, and the verification section 14 to convey all of the banknotes held in the temporary holding section 15 in sequence toward the front to be replaced in the container 12A of the deposit/withdrawal section 12, and opens the shutter 12B to return the banknotes to the customer.

If the customer instructs the banknote control section 11 to continue with the deposit processing, the banknote control section 11 starts the deposit storage processing, illustrated in FIG. 8. Specifically, the banknote control section 11 first starts feed-out processing in the temporary holding section 15, thereby feeding out the stored banknotes (deposit acceptable banknotes) in sequence to be passed downstream to the temporary holding switching section 20, as illustrated by the arrow Q5.

When this is performed, the temporary holding section 15 coordinates the linear speed of the circumferential side face of the drum 41 (FIG. 5), the running speed of the tape 44, and the banknote conveyance speed of the temporary holding conveyance section 42 with the conveyance speed of the first conveyance section 21 and the second conveyance section 22, thereby passing the banknotes in sequence downstream to the temporary holding switching section 20 in the opposite sequence to when storing the banknotes, while restoring the conveyance state at the time of storage, namely the angle of each banknote with respect to the conveyance direction, the front-rear spacing between the banknotes, and the like.

When this is performed, the temporary holding section 15 uses the run monitoring sensor 43 (FIG. 5) to detect the conveyance state of the banknotes, and sends the detection results to the banknote control section 11. In response, the banknote control section 11 employs the obtained detection results as information during feed-out from the temporary holding section 15, and this is compared against the information during storage stored in the storage section 11M to consecutively determine whether or not the conveyance state at the time of storage has been correctly restored.

For banknotes for which the conveyance state at the time of storage has been correctly restored, the banknote control section 11 considers that the conveyance destination decided for that respective banknote based on the verification results acquired from the verification section 14 during deposit counting processing can be employed as it is, and switches the conveyance path of the temporary holding switching section 20 according to that conveyance destination. Namely, the temporary holding switching section 20 switches the conveyance path such that the banknote is passed downstream to the first conveyance section 21 if the conveyance destination is the reject box 16 or the banknote storage box 17A, and such that the banknote is passed downstream to the second conveyance section 22 if the conveyance destination is the banknote storage boxes 17B to 17E or the counterfeit note box 18.

The banknote control section 11 controls the respective switching sections of the first conveyance section 21 and the second conveyance section 22 as appropriate according to the conveyance destination of each banknote, thereby conveying the respective banknotes to their conveyance destinations to be stored, as illustrated by the arrow Q6 and the arrow Q7. In this manner, the banknote control section 11 is capable of storing banknotes that are unsuitable for re-use in the reject box 16, storing normal banknotes that are suitable for re-use in the respective banknote storage boxes 17 by denomination, and storing banknotes that have been determined to be counterfeit notes in the counterfeit note box 18.

For a banknote for which the conveyance state at the time of storage has not been correctly restored, the banknote control section 11 considers that the decided conveyance destination should not be employed, and changes the conveyance destination of that banknote and of subsequent banknotes to the reject box 16. Note that banknotes for which the conveyance state at the time of storage has not been correctly restored include, for example, banknotes for which the angle with respect to the conveyance direction (what is referred to as the skew) or the spacing between the banknotes differs from at the time of storage, and banknotes that are in a state adjoining another banknote (namely with overlapping conveyance, or strings of touching banknotes). Specifically, the temporary holding switching section 20 passes the banknotes downstream to the first conveyance section 21 in sequence, as illustrated by the arrow Q7.

When this is performed, the banknote control section 11 re-verifies the banknotes in the verification section 14, and uses the first conveyance section 21 to convey the banknotes to the reject box 16 after re-identifying the denomination, serial number, and conveyance speed of the banknotes in particular. Note that the banknote control section 11 references information regarding the identified denomination, serial number, and conveyance state and the like of the banknotes against the information during counting that was stored during the deposit counting processing. In cases in which a high proportion of the information matches, the banknote control section 11 determines that the conveyance destination decided during the deposit counting processing may be employed for that banknote, and for subsequent banknotes.

When this occurs, the banknote control section 11 conveys this banknote and the subsequent banknotes back in the opposite direction to be stored upstream in the temporary holding section 15 again, and switches the conveyance path of the temporary holding switching section 20 to convey and store the banknotes according to the conveyance destination decided for each banknote. Note that in cases in which the identified denomination, serial number, and conveyance state of a banknote do not match the denomination, serial number, and deposit conveyance state stored during the deposit counting processing, the banknote control section 11 considers this banknote to be non-reusable, and conveys the banknote to the reject box 16 to be stored.

In this manner, during deposit processing, the banknote deposit/withdrawal device 10 stores the banknotes in the temporary holding section while deciding the conveyance destinations for each of the banknotes when the banknotes are verified in the early stage deposit counting processing. Next, when the banknote deposit/withdrawal device 10 is instructed to continue with the deposit processing, the respective banknotes are conveyed to their pre-decided conveyance destinations without re-verifying the respective banknotes with the verification section 14 during the later stage deposit storage processing.

1-3-2. Withdrawal Processing

Next, explanation follows regarding withdrawal processing performed when a customer withdraws banknotes from the ATM 1, with reference to FIG. 9. In withdrawal processing, under control of the banknote control section 11, the banknote deposit/withdrawal device 10 performs withdrawal processing to withdrawal banknotes in numbers and denominations that make up an instructed withdrawal amount.

Specifically, first the banknote control section 11 receives input of a specific operation, including a withdrawal amount, from the customer through the operation and display section 6 (FIG. 1), and decides the numbers and denominations of banknotes to make up the withdrawal amount. The banknote control section 11 then separates and feeds out banknotes stored in a stacked state inside the respective banknote storage boxes 17 one note at a time according to the decided numbers and denominations, and passes the banknotes in sequence downstream to the first conveyance section 21 or second conveyance section 22.

When this is performed, for banknotes stored in the banknote storage boxes 17B to 17E, as illustrated by arrow Q8, the respective switching sections of the second conveyance section 22 are switched as appropriate to convey the banknotes toward the front, and the banknotes are passed through the temporary holding switching section 20 to the first conveyance section 21. However, due to constraints of the first switching section 24 of the first conveyance section 21, although the banknote control section 11 can convey banknotes fed out from the banknote storage box 17A to the short conveyance path on the rear side, the banknote control section 11 cannot convey banknotes fed out from the banknote storage box 17A directly to the short conveyance path on the front side, nor to the verification section 14. Accordingly, as illustrated by the arrow Q9, using the temporary holding switching section 20, the banknote control section 11 temporarily stores the banknotes that were stored in the banknote storage box 17A in the temporary holding section 15, and then, as illustrated by the arrow Q10, feeds the banknotes out from the temporary holding section 15 in sequence to be transported toward the front inside the first conveyance section 21.

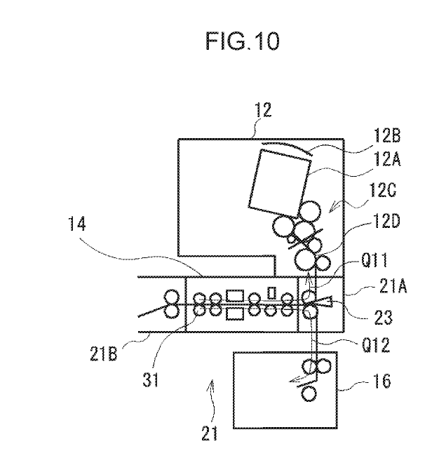

Next, as illustrated in FIG. 10, the banknote control section 11 uses the verification section 14 to verify the banknotes travelling toward the front in the rear part 21B of the first conveyance section 21. Note that, initially, the banknote control section 11 detects only a running state of the banknote with the run sensor 31 positioned further toward the rear inside the verification section 14, and immediately sends a detection result thereof to the banknote control section 11. In response, the banknote control section 11 decides the conveyance destination to be either the deposit/withdrawal section 12 or the reject box 16 based on the running state of the banknote.

Specifically, if there is nothing wrong with the running state of the banknote, the banknote control section 11 forms a conveyance path linking between the deposit/withdrawal section 12 at the upper side and the verification section 14 at the rear side in the reject switching section 23 of the first conveyance section 21, and as illustrated by the arrow Q11, conveys the banknote downstream to the deposit/withdrawal section 12 to be discharged into the container 12A.

If there is an issue with the running state of the banknote, for example overlapping conveyance, the banknote control section 11 forms a conveyance path linking the verification section 14 at the rear side to the reject box 16 at the lower side in the reject switching section 23, and as illustrated by the arrow Q12, conveys the banknote downstream to the reject box 16 to be stored.

Note that after the verification section 14 has detected the running state with the run sensor 31 positioned on the upstream side and sent the detection result to the banknote control section 11, the verification section 14 sends the banknote control section 11 detection results from the image sensor 32 and the authenticity sensor 33 positioned on the downstream side. Namely, the banknote control section 11 acquires detection results from the image sensor 32 and the authenticity sensor 33 after the conveyance destinations of the respective banknotes have been decided according to the running state by the run sensor 31.

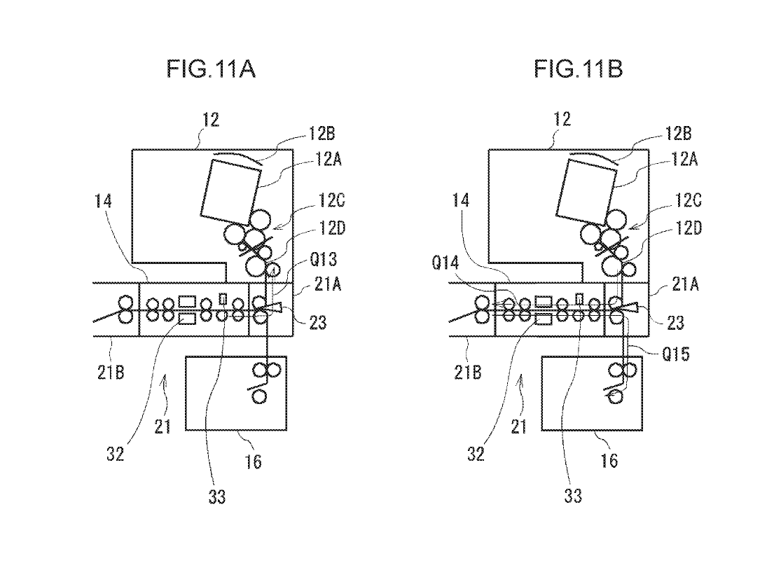

Accordingly, in cases in which the image sensor 32 or the authenticity sensor 33 detects that a banknote is not a normal banknote and should not be withdrawn, as illustrated by the arrow Q13 in FIG. 11A, the banknote control section 11 immediately stops the banknote that is being conveyed, namely partway through conveyance by the front part 21A of the first conveyance section 21 and the deposit/withdrawal conveyance section 12D of the deposit/withdrawal section 12. Moreover, after the conveying the banknote back in the opposite direction to reach the rear side of the verification section 14 as illustrated by the arrow Q14 in FIG. 11B, the banknote control section 11 sets the conveyance destination of this banknote alone as the reject box 16, and switches the reject switching section 23 to convey the banknote to the reject box 16 as illustrated by the arrow Q15.

The banknote control section 11 then switches the reject switching section 23 again so as to convey subsequent normal banknotes downstream to the deposit/withdrawal section 12. Finally, when the banknote control section 11 has finished discharging all of the banknotes making up the withdrawal amount into the container 12A of the deposit/withdrawal section 12, the banknote control section 11 opens the shutter 12B to allow the customer to take out the banknotes.

In this manner, during withdrawal processing, the banknote deposit/withdrawal device 10 conveys banknotes making up the withdrawal amount from the respective upstream banknote storage boxes 17 downstream to the deposit/withdrawal section 12 to be passed to the customer, while switching the reject switching section 23 based on the detection results of the run sensor 31 of the verification section 14.

### 1-4. Effects, Etc.

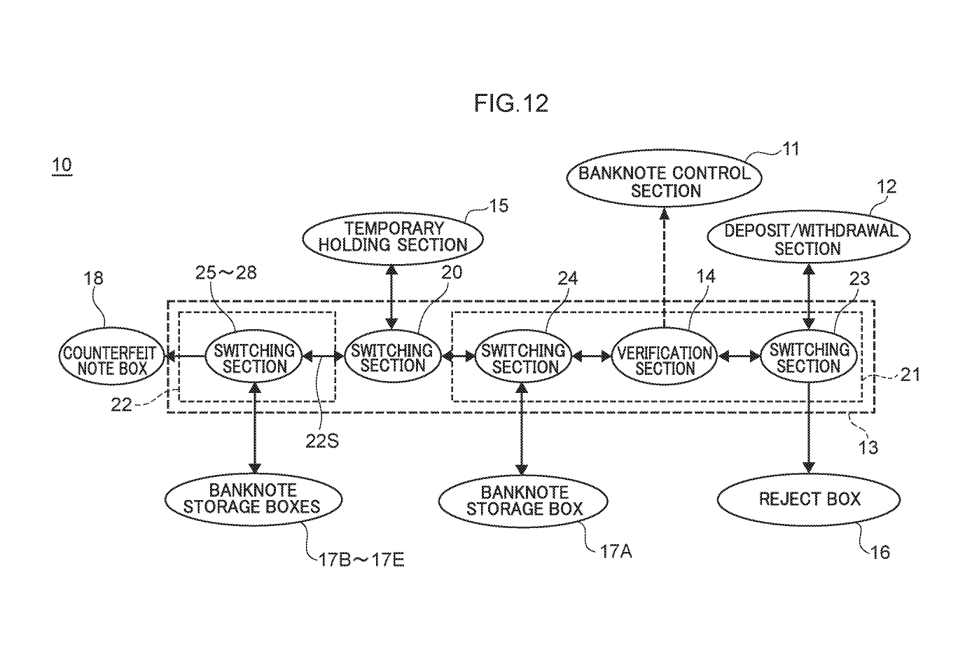

In the above configuration, as schematically illustrated in FIG. 12, the banknote deposit/withdrawal device 10 of the ATM 1 according to the first exemplary embodiment is configured such that the deposit/withdrawal section 12, the verification section 14, the temporary holding section 15, the reject box 16, the banknote storage boxes 17, and the counterfeit note box 18 are respectively connected to the conveyance section 13 that is formed in a straight line shape along the front-rear direction. Note that in FIG. 12, the arrows indicate conveyance directions of the banknotes. Also note that in FIG. 12, for ease of illustration, the temporary holding switching section 20, the reject switching section 23, the first switching section 24 to the fourth switching section 27, and the counterfeit note switching section 28 are all simply denoted as “switching sections”.

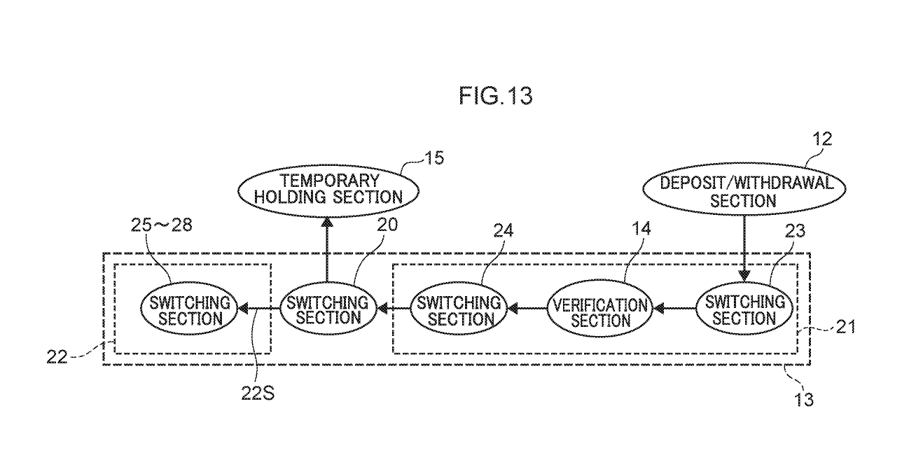

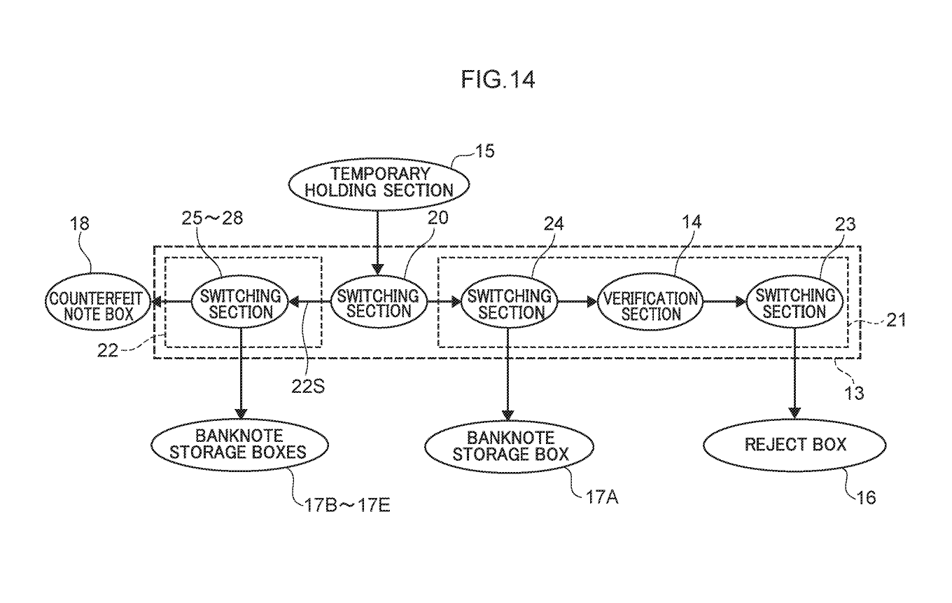

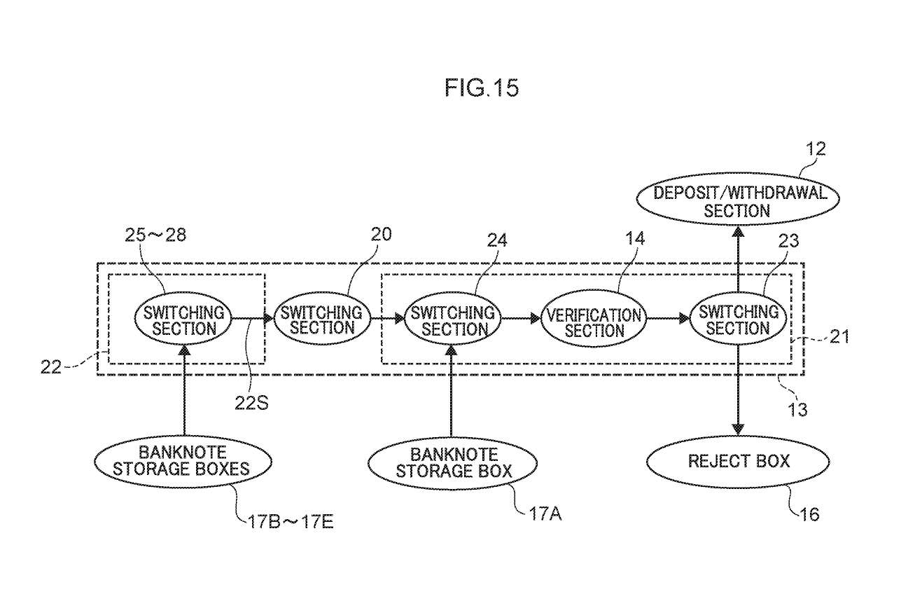

The flow of banknotes during the deposit counting processing, the deposit storage processing, and the withdrawal processing of the banknote deposit/withdrawal device 10 can be respectively expressed as in FIG. 13, FIG. 14, and FIG. 15 if expressed using schematic drawings corresponding to FIG. 12.

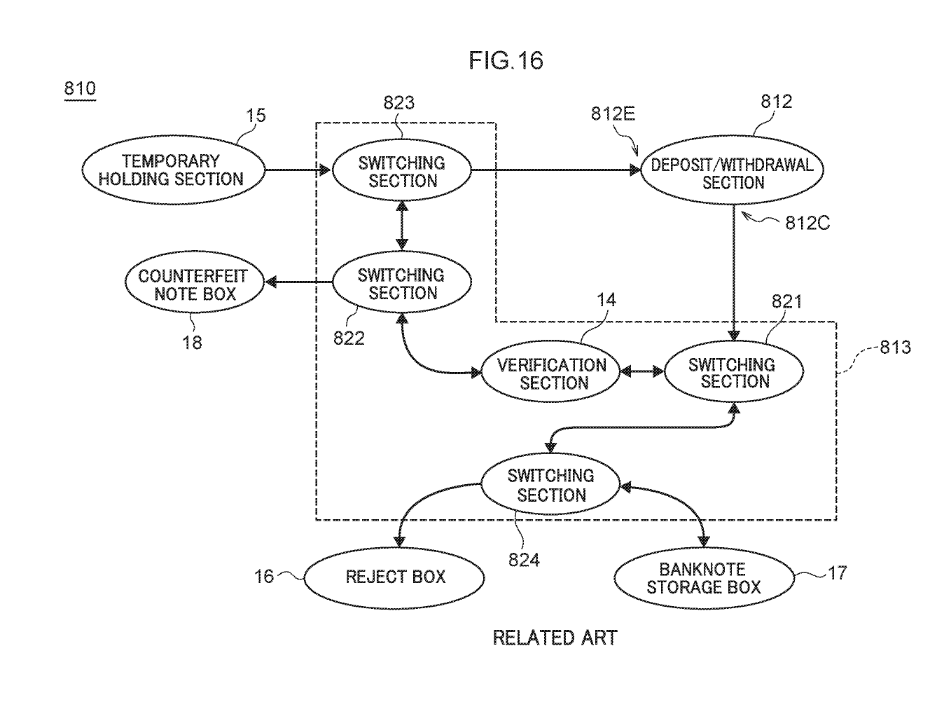

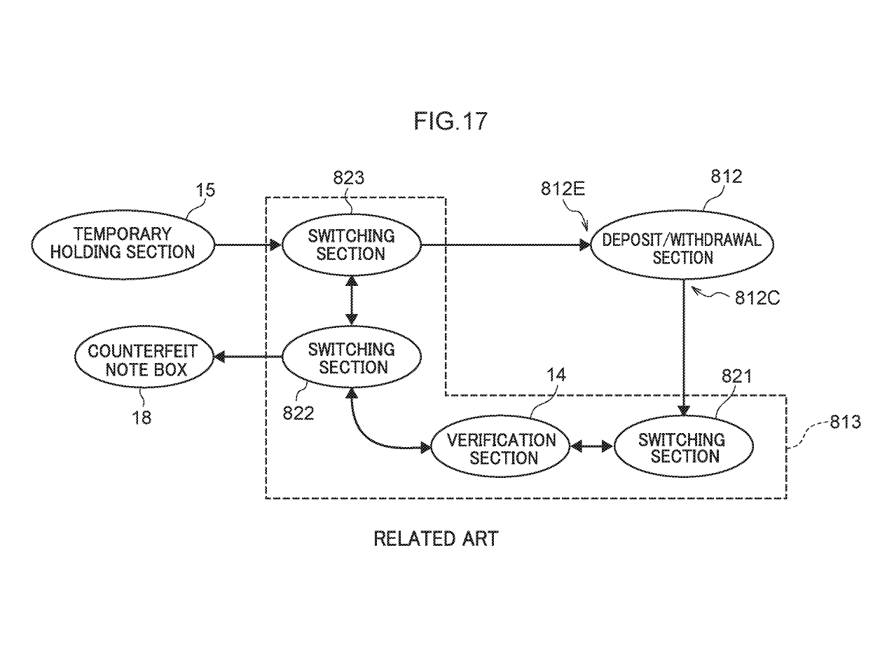

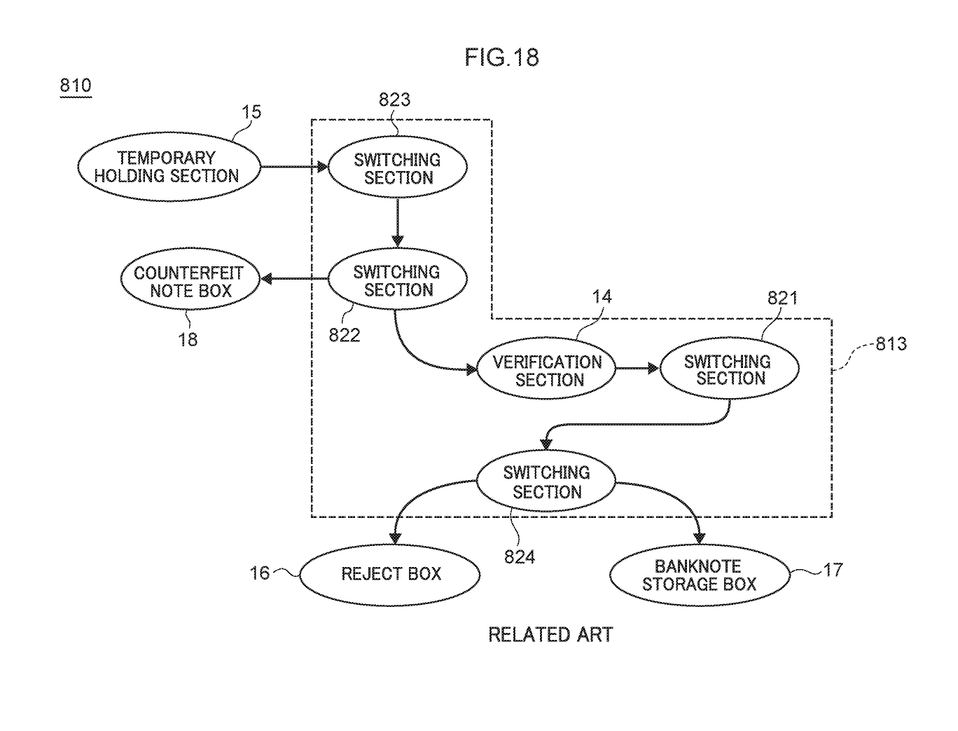

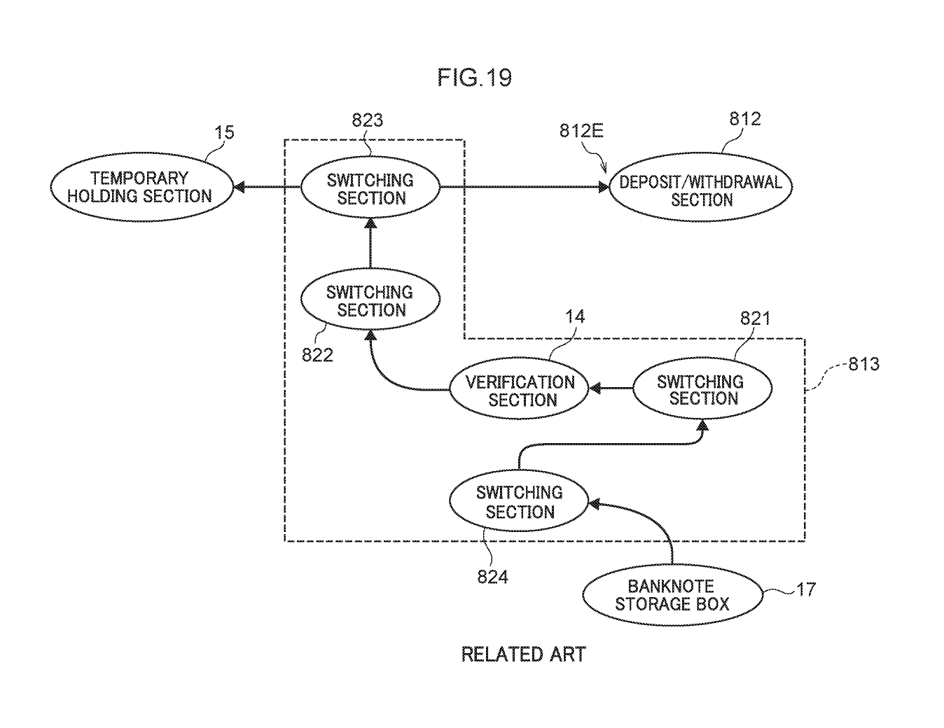

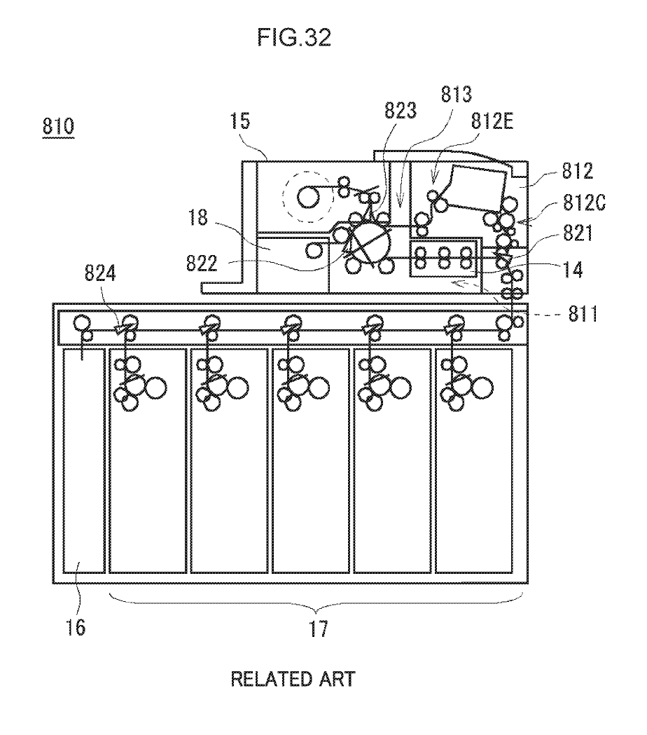

The conventional banknote deposit/withdrawal device 810 illustrated in FIG. 32 can be expressed as in FIG. 16 in a schematic drawing corresponding to FIG. 12. Moreover, the flow of banknotes in deposit counting processing, deposit storage processing, and withdrawal processing of the conventional banknote deposit/withdrawal device 810 can be respectively expressed as in FIG. 17, FIG. 18, and FIG. 19 if expressed using schematic drawings corresponding to FIG. 16.

Looking at FIG. 16, the conveyance path of the conveyance section 813 is formed as a loop shaped (ring shaped) conveyance path that reaches from a take-in port 812C of the deposit/withdrawal section 812 to a discharge port 812E of the deposit/withdrawal section 812 through the switching section 821, the verification section 14, the switching section 822, and the switching section 823.

As can be seen from FIG. 17, in the conventional banknote deposit/withdrawal device 810, when a deposit reject banknote arises during the deposit counting processing, the loop shaped conveyance path can be employed to convey the deposit reject banknote directly to the discharge port 812E of the deposit/withdrawal section 812. The conventional banknote deposit/withdrawal device 810 is thereby able to respond without interrupting deposit processing since deposit reject banknotes can be replaced in the deposit/withdrawal section 812 as needed, even when a large number of deposit reject banknotes arise.

However, it has been found that, although there is variation by country or region, the frequency with which deposit reject banknotes arise is very low, for example around 1% to 2%, when calculated for real-life deposit processing. For example, since the conventional banknote deposit-withdrawal device 810 is capable of processing up to a maximum of around 100 to 200 banknotes during a single transaction processing event, the number of deposit reject banknotes that may be expected to arise in real life is around four or five banknotes at most. Accordingly, as long as a banknote deposit/withdrawal device can be provided with sufficient locations to temporarily retain a maximum of around four or five deposit reject banknotes, and the deposit reject banknotes can be conveyed to the deposit/withdrawal section 812, it is not necessary to configure a loop shaped conveyance path.

Drawing on this technical concept, since banknotes are not conveyed to the banknote storage boxes 17 during the deposit counting processing in the banknote deposit/withdrawal device 10 according to the present exemplary embodiment, the conveyance path of the second conveyance section 22 that is therefore unused is designated as the conveyance path retention section 22S in which deposit reject banknotes are retained (FIG. 6, FIG. 7).

From another perspective, in the banknote deposit/withdrawal device 10, the conveyance section 13 forms a straight line shaped conveyance path that passes through the verification section 14, and the deposit/withdrawal section 12 and the reject box 16 are disposed on the conveyance path on one side (for example the front side) of the verification section 14, and the temporary holding section 15 and the banknote storage boxes 17 are respectively disposed on the conveyance path on the other side (for example the rear side) of the verification section 14 (FIG. 12). To put this another way, in the banknote deposit/withdrawal device 10, conveyance paths in which one, or two or more, switching sections are connected in series are respectively connected to both ends of a conveyance path passing through the verification section 14.

From yet another perspective, in the banknote deposit/withdrawal device 10, the temporary holding switching section 20 switches to connect together any two out of a conveyance path heading toward the deposit/withdrawal section 12, a conveyance path heading toward the banknote storage boxes 17, and the temporary holding section 15. In addition, in the banknote deposit/withdrawal device 10, the verification section 14 is disposed on the conveyance path heading toward the deposit/withdrawal section 12, and as viewed from the verification section 14, the reject box 16 is connected to the conveyance path on the deposit/withdrawal section 12 side through the reject switching section 23 (FIG. 12).

Accordingly, in the banknote deposit/withdrawal device 10, the conveyance path of the conveyance section 13 is configured in a straight line shape rather than a loop shape, while employing a configuration capable of appropriately performing deposit counting processing. The banknote deposit/withdrawal device 10 thereby enables a simpler configuration than that of the conventional banknote deposit/withdrawal device 810, enables a reduction in size and a reduction in the number of components, and also enables an accompanying reduction in the frequency of breakdowns and a reduction in the amount of work required in maintenance operations and the like.

Moreover in the banknote deposit/withdrawal device 10, supposing a large number of deposit reject banknotes were to arise that could not all be retained inside the conveyance path retention section 22S, the deposit counting processing is interrupted, and the deposit reject banknotes retained in the conveyance path retention section 22S are replaced in the deposit/withdrawal section 12, and can be confirmed, for example visually, by the customer and then reinserted, thereby enabling deposit counting processing to be continued.

In such cases, in the banknote deposit/withdrawal device 10, conveyance of banknotes from the deposit/withdrawal section 12 to the temporary holding section 15 is paused, and the deposit reject banknotes are conveyed to be replaced in the deposit/withdrawal section 12, thereby causing a large increase in the time needed to complete the deposit counting processing compared to hitherto. However, in the banknote deposit/withdrawal device 10, the likelihood of detecting a large number of deposit reject banknotes during deposit processing is very low, as described above. Accordingly, the average amount of time needed for the deposit counting processing may be reduced in comparison to the conventional banknote deposit/withdrawal device 810 due to reducing the conveyance path length.

Moreover, the banknote deposit/withdrawal device 10 enables determination to be made as to whether or not a rear edge of a banknote retained inside the conveyance path retention section 22S has reached the rear end of the conveyance path retention section 22S based on the rotation rate and rotation angle of the motor driving the respective rollers in the second conveyance section 22. The banknote deposit/withdrawal device 10 may accordingly detect the position of the rear edge of a banknote inside the conveyance path retention section 22S, and detect whether or not the conveyance path retention section 22S is full, without separately providing a dedicated optical sensor or the like.

Moreover, as can be seen from FIG. 18, in the conventional banknote deposit/withdrawal device 810, during the deposit storage processing, the denomination and level of damage of a banknote fed out from the temporary holding section 15 are verified as the banknote passes the verification section 14. The conveyance destination of the banknote is then decided, and the banknote is conveyed thereto. Accordingly, in the conveyance section 813 it is necessary to form a conveyance path passing through the verification section 14 and heading toward the banknote storage boxes 17 for banknotes fed out from the temporary holding section 15.

However, in the conventional banknote deposit/withdrawal device 810, banknotes could be verified by the verification section 14, and verified by level of damage and denomination, during the process of conveying the banknotes from the deposit/withdrawal section 12 to the temporary holding section 15 during the early stage deposit counting processing. Moreover, due to the temporary holding section 15 (FIG. 5) employing what is referred to as a tape escrow method, in which the respective banknotes are wrapped onto the drum 41 together with the tape 44 and stored, the banknotes can be stored and fed out with the sequence of the banknotes, the spacing between the banknotes, and the skew and the like preserved. In other words, in the temporary holding section 15, unlike in a method in which banknotes are stacked and stored, such as in the banknote storage boxes 17 in which banknotes are separated as they are fed out, new overlapping conveyance or sequence reversal are fundamentally very unlikely to arise, enabling good preservation of the conveyance state when storing.

Drawing on this technical concept, in the banknote deposit/withdrawal device 10 according to the present exemplary embodiment, the verification results obtained from the verification section 14 and the conveyance destination decided based thereon are stored during the deposit counting processing, and conveyance to the stored conveyance destination is performed during the deposit storage processing (FIG. 8). Accordingly in the banknote deposit/withdrawal device 10, a conveyance path that conveys banknotes fed out from the temporary holding section 15 to the banknote storage boxes 17 and the like without passing through the verification section 14 is formed in the conveyance section 13, thereby enabling shorter conveyance paths and simpler configuration than in the conventional banknote deposit/withdrawal device 810.

In the banknote deposit/withdrawal device 10, when storing banknotes in the temporary holding section 15, the conveyance state of the banknotes is detected by the run monitoring sensor 43 and saved in the storage section 11M of the banknote control section 11 as the conveyance information during storage. The conveyance state of the banknotes when they are fed out is detected again by the run monitoring sensor 43 and employed as conveyance information during feed-out that is referenced against the conveyance information during storage.

In this manner, the banknote deposit/withdrawal device 10 may detect a change in the conveyance state from a large difference in the referencing results, even if, for example, a banknote being conveyed inside temporary holding section 15 becomes caught on its surroundings, causing new skew or overlapping conveyance. In such cases, the banknote deposit/withdrawal device 10 considers that the banknote whose conveyance state has changed, as well as subsequent banknotes, to be banknotes that are unsuitable for re-use, and conveys them to the reject box 16 to be stored, thereby pre-empting issues of the wrong banknotes being sent to the conveyance destinations stored during the deposit counting processing.

In the banknote deposit/withdrawal device, the verification section 14 is disposed between the temporary holding section 15 and the reject box 16, thereby enabling banknotes heading toward the reject box 16 to be re-verified by the verification section 14. When this is performed, the banknote deposit/withdrawal device 10 compares the re-verification results obtained from the verification section 14 against the conveyance information during storage stored during the deposit counting processing, thereby enabling the conveyance information during storage corresponding to a banknote to be found based on the denomination and the serial number in particular.

In such cases, the banknote deposit/withdrawal device 10 considers that the conveyance information during storage for this banknote and subsequent banknotes can be employed, and uses the first conveyance section 21 and the like to convey this banknote and subsequent banknotes back in the opposite direction to further to the temporary holding section 15 side than the temporary holding switching section 20, namely to inside the temporary holding section 15, before conveying the banknotes to be stored in the appropriate conveyance destinations based on the conveyance information during storage. This thereby enables the banknote deposit/withdrawal device 10 to effectively re-use banknotes would essentially be reusable but for the fact that their conveyance state has changed, to be conveyed to the banknote storage boxes 17 and stored, without unnecessarily conveying banknotes to the reject box 16.

Moreover, as can be seen from FIG. 19, in the conventional banknote deposit/withdrawal device 810, during withdrawal processing, the conveyance path is switched by a switching section 820 according to the verification results of the verification section 14, so as to convey normal banknotes that can be withdrawn to the deposit/withdrawal section 12, and convey reject banknotes that are unsuitable for withdrawal to the temporary holding section 15.

Namely, in the banknote deposit/withdrawal device 810, it is necessary for the banknote control section 811 to decide the conveyance destination of a banknote verified by the verification section 14 based on the verification results of the respective sensors of the verification section 14, and complete the switching operation of the switching section 820, prior to the banknote reaching the switching section 820. Accordingly in the banknote deposit/withdrawal device 810, the conveyance path from the verification section 14 to the switching section 820 is relatively long.

However, the banknotes fed out from the banknote storage boxes 17 during withdrawal processing are banknotes that are in a good state and can be withdrawn, having been verified as reusable by the verification section 14 during deposit processing, or having been loaded into the banknote storage boxes 17 by a member of staff of the financial institution or the like when removed from the conventional banknote deposit/withdrawal device 810. Accordingly in the conventional banknote deposit/withdrawal device 810, when reject banknotes arise during withdrawal processing, this is predominantly due to issues with the conveyance state, such as skew or overlapping conveyance, and the likelihood of a reject banknote being due to detection of an incorrect denomination or counterfeit note is very low.

Namely, during withdrawal processing, even were the conveyance destination of a banknote to be decided based only on the detection result of the banknote from the run sensor 31 of the verification section 14 (FIG. 14), the likelihood of this decision being overturned by the detection results of the image sensor 32 or the authenticity sensor 33 is very low.

Based on this technical concept, in the banknote deposit/withdrawal device 10 according to the present exemplary embodiment, during withdrawal processing, the banknote control section 11 decides the conveyance destination of each banknote to be the deposit/withdrawal section 12 or the reject box 16 based only on the detection result from the run sensor 31 of the verification section 14, and switches the conveyance path of the reject switching section 23 of the first conveyance section 21 accordingly (FIG. 10). This thereby enables the banknote deposit/withdrawal device 10 to keep the conveyance path from the front end of the verification section 14 to the reject switching section 23 relatively short, enabling contribution to the simplification of the device configuration and a reduction in size, and in particular, a reduction in the front-rear length of the overall device, in comparison to the conventional banknote deposit/withdrawal device 810.

In the banknote control section 11 of the banknote deposit/withdrawal device 10, sometimes even after the conveyance destination of a banknote has been decided as the deposit/withdrawal section 12 based on the detection result of the run sensor 31, and the conveyance path of the reject switching section 23 has been switched, the conveyance destination of the banknote is changed to the reject box 16 based on the detection results of the image sensor 32 or the authenticity sensor 33.

In such cases, the banknote has already passed the reject switching section 23 and has reached the conveyance path inside the front part 21A of the first conveyance section 21 or the conveyance path toward the take-in/discharge port 12C of the deposit/withdrawal section 12. Accordingly, the banknote control section 11 immediately stops conveyance of the banknote by the deposit/withdrawal section 12, and conveys the banknote back in the opposite direction as far as the rear side of the verification section 14, and switches the conveyance path of the reject switching section 23 toward the reject box 16 side (FIG. 11A, FIG. 11B). The banknote deposit/withdrawal device 10 may convey the banknote to the reject box 16, without incorrectly discharging the banknote into the container 12A of the deposit/withdrawal section 12.

When this is performed, the banknote deposit/withdrawal device 10 pauses conveyance of the banknote, and then conveys the banknote back in the opposite direction, thus increasing the time needed to complete the withdrawal processing. However, as described above, since the likelihood of detecting an incorrect denomination or counterfeit note during withdrawal processing is very low, due to reducing the length of the conveyance paths, the banknote deposit/withdrawal device 10 may reduce the average amount of time needed for withdrawal processing compared to the conventional banknote deposit/withdrawal device 810.

Due to the above configuration, in the banknote deposit/withdrawal device 10 of the ATM 1 according to the first exemplary embodiment, the conveyance path inside the conveyance section 13 is formed in a straight line shape, mainly along the front-rear direction. During deposit processing, in the deposit counting processing the banknote deposit/withdrawal device 10 retains deposit reject banknotes in the conveyance path retention section 22S of the second conveyance section 22, and decides and stores the conveyance destination of each banknote based on the verification results obtained from the verification section 14. In the deposit storage processing, the banknotes fed out from the temporary holding section 15 are conveyed to their decided conveyance destinations to be stored. During withdrawal processing, the banknote deposit/withdrawal device 10 decides the conveyance destination of banknotes based on the detection results of the run sensor 31 of the verification section 14. Accordingly, the banknote deposit/withdrawal device 10 may enable a simpler configuration and a reduction in size, and may also reduce processing time due to the reduction in the length of the conveyance path in comparison to hitherto, while still accomplishing the same processing.

### 2. Second Exemplary Embodiment

An ATM 101 (FIG. 1) according to a second exemplary embodiment differs from the ATM 1 according to the first exemplary embodiment in the point that a banknote deposit/withdrawal device 110 is provided in place of the banknote deposit/withdrawal device 10, while being similarly configured in other respects.

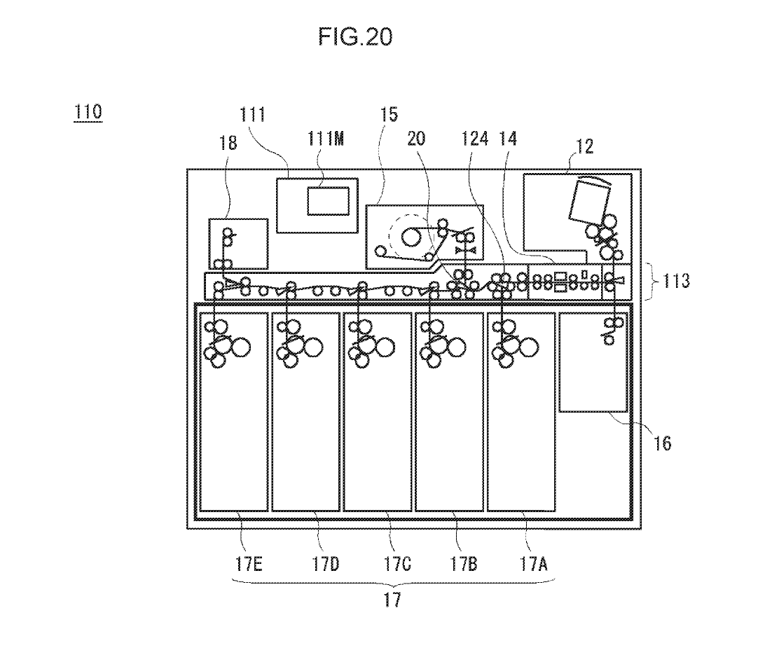

As illustrated in FIG. 20 corresponding to FIG. 2, the banknote deposit/withdrawal device 110 differs from the banknote deposit/withdrawal device 10 according to the first exemplary embodiment in the point that a banknote control section 111 and a conveyance section 113 are provided in place of the banknote control section 11 and the conveyance section 13, while being similarly configured in other respects.

Similarly to the banknote control section 11 according to the first exemplary embodiment, the banknote control section 111 is configured around a CPU (not illustrated in the drawings), and reads and executes specific programs from ROM (not illustrated in the drawings), flash memory, or the like to perform various processing such as processing to decide banknote conveyance destinations and processing to control operation of the respective sections. In the banknote control section 111, a storage section 111M provided in place of the storage section 11M is stored with various information.

The conveyance section 113 differs from the conveyance section 13 (FIG. 4) in the point that a first switching section 124 is provided in place of the first switching section 24 inside the first conveyance section 121 on the front side, while being similarly configured in other respects.

The first switching section 124 includes what is referred to as a three-way blade, similarly to the temporary holding switching section 20 of the first exemplary embodiment (FIG. 4), and is capable of switching the conveyance path three ways. Specifically, the first switching section 124 forms a conveyance path linking a short conveyance path at the rear side to the banknote storage box 17A at the lower side, a conveyance path linking the short conveyance path at the rear side and a short conveyance path at the front side, and a conveyance path linking the short conveyance path at the front side and the banknote storage box 17A at the lower side.

Accordingly, during withdrawal processing, the banknote deposit/withdrawal device 110 may transport banknotes fed out from the banknote storage box 17A directly toward the front inside the first conveyance section 121 of the conveyance section 113 under the control of the banknote control section 111, and going on to convey the banknotes straight through the verification section 14 to the deposit/withdrawal section 12 or the reject box 16.

Note that in the banknote deposit/withdrawal device 110, the distance between the verification section 14 and the first switching section 124 is very short, and so when a banknote is being conveyed toward the rear in the first conveyance section 121, the banknote passes the first switching section 124 before completing switching of the conveyance path of the first switching section 124 based on the detection results of the respective sensors of the verification section 14. Accordingly, in the banknote deposit/withdrawal device 110, banknotes are conveyed to and stored in any one of the banknote storage boxes 17B to 17E during deposit processing.

In the above configuration, the banknote deposit/withdrawal device 110 of the ATM 101 according to the second exemplary embodiment switches the conveyance path three ways using the first switching section 124 of the conveyance section 113 that has a conveyance path formed in a straight line shape along the front-rear direction.

Accordingly, the banknote deposit/withdrawal device 110 may convey banknotes fed out from the banknote storage box 17A directly toward the front inside the first conveyance section 21, to be conveyed to the deposit/withdrawal section 12 or the reject box 16 through the verification section 14. This thereby enables the banknote deposit/withdrawal device 110 to perform withdrawal swiftly, without needing to use the temporary holding section 15 as in the first exemplary embodiment, when feeding out banknotes to be withdrawn from the banknote storage box 17A.

In other respects, the banknote deposit/withdrawal device 110 may exhibit similar operation and effects to the banknote deposit/withdrawal device 10 according to the first exemplary embodiment.

According to the above configuration, due to switching the conveyance path three ways with the first switching section 124 of the conveyance section 113, the banknote deposit/withdrawal device 110 of the ATM 101 according to the second exemplary embodiment may transport banknotes directly toward the front inside the first conveyance section 121 when feeding out banknotes stored in the banknote storage box 17A. This thereby enables smooth withdrawal processing that does not employ the temporary holding section 15.

### 3. Third Exemplary Embodiment

An ATM 201 (FIG. 1) according to a third exemplary embodiment differs from the ATM 1 according to the first exemplary embodiment in the point that a banknote deposit/withdrawal device 210 is provided in place of the banknote deposit/withdrawal device 10, while being similarly configured in other respects.

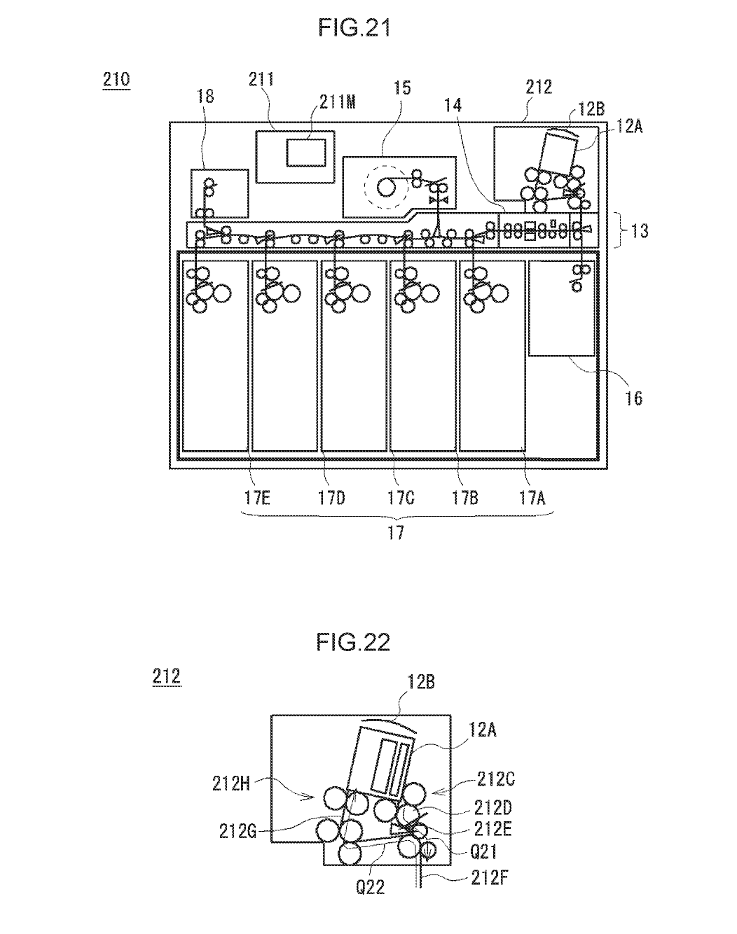

As illustrated in FIG. 21 corresponding to FIG. 2, the banknote deposit/withdrawal device 210 differs from the banknote deposit/withdrawal device 10 according to the first exemplary embodiment in the point that a banknote control section 211 and a deposit/withdrawal section 212 are provided in place of the banknote control section 11 and the deposit/withdrawal section 12, while being similarly configured in other respects.

Similarly to the banknote control section 11 according to the first exemplary embodiment, the banknote control section 211 is configured around a CPU (not illustrated in the drawings), and reads and executes specific programs from ROM (not illustrated in the drawings), flash memory, or the like to perform various processing such as processing to decide banknote conveyance destinations and processing to control operation of the respective sections. In the banknote control section 211, a storage section 211M provided in place of the storage section 11M is stored with various information.

As illustrated in enlarged view in FIG. 22, in the deposit/withdrawal section 212 a container 12A and a shutter 12B are configured similarly to in the deposit/withdrawal section 12, but other sections differ. Specifically, instead of the take-in/discharge port 12C and the deposit/withdrawal conveyance section 12D, the deposit/withdrawal section 212 includes a take-in port 212C, a take-in conveyance section 212D, a switching section 212E, a deposit/withdrawal conveyance section 212F, a discharge conveyance section 212G, and a discharge port 212H.

The take-in port 212C and the discharge port 212H separate the take-in function and the discharge function of the take-in/discharge port 12C of the first exemplary embodiment, and are disposed apart from each other at the front and rear of a lower end of the container 12A. The take-in port 212C and the discharge port 212H are connected to the switching section 212E through the take-in conveyance section 212D and the discharge conveyance section 212G at their respective lower sides.

The switching section 212E switches the banknote conveyance path to form a conveyance path connecting the deposit/withdrawal conveyance section 212F to the take-in conveyance section 212D, or to form a conveyance path connecting the deposit/withdrawal conveyance section 212F to the discharge conveyance section 212G. The deposit/withdrawal conveyance section 212F is also connected to the conveyance section 13.

In the above configuration, the banknote deposit/withdrawal device 210 of the ATM 201 according to the third exemplary embodiment is provided with the deposit/withdrawal section 212 that includes the mutually independent take-in port 212C and discharge port 212H at the front and rear of the container 12A in addition to the conveyance section 13 that is similar to that of the first exemplary embodiment.

When banknotes are taken in during the deposit counting processing, under the control of the banknote control section 211, first, the deposit/withdrawal section 212 uses the switching section 212E to form a conveyance path connecting the take-in conveyance section 212D and the deposit/withdrawal conveyance section 212F. Then as illustrated by the arrow Q21, the deposit/withdrawal section 212 uses the take-in port 212C to separate and take in the banknote positioned furthest to the front side out of the banknotes contained in the container 12A, namely the banknote at the head of the banknotes arranged in a line. The deposit-withdrawal section 212 also uses the take-in conveyance section 212D, the switching section 212E, and the deposit/withdrawal conveyance section 212F to convey banknotes downward to be passed to the conveyance section 13 in sequence.

The banknote control section 211 then performs deposit counting processing that is substantially the same as that of the first exemplary embodiment, with the exception of elements relating to the deposit/withdrawal section 212. Namely, the banknote control section 211 verifies the banknotes taken in from the deposit/withdrawal section 212 using the verification section 14 while conveying the banknotes with the first conveyance section 21 of the conveyance section 13. When this is performed, the banknote control section 211 controls the temporary holding switching section 20 to switch the conveyance path based on the obtained verification results. Specifically, the banknote control section 211 conveys deposit acceptable banknotes to the temporary holding section 15, and retains deposit reject banknotes in sequence inside the conveyance path retention section 22S of the second conveyance section 22.

Then, in cases in which all of the banknotes contained in the deposit/withdrawal section 212 have been taken in and verification by the verification section 14 has been finished, and one or more deposit reject banknotes are retained inside the conveyance path retention section 22S, then similarly to in the first exemplary embodiment, the banknote control section 211 uses the temporary holding switching section 20 and the first conveyance section 21 to convey all of the deposit reject banknotes to the deposit/withdrawal section 212 in sequence.

When this is performed, first, under the control of the banknote control section 211, the deposit/withdrawal section 212 uses the switching section 212E to form a conveyance path connecting the discharge conveyance section 212G and the deposit/withdrawal conveyance section 212F. Then, as illustrated by the arrow Q22, the deposit/withdrawal section 212 conveys the banknotes passed in sequence from the conveyance section 13 using the deposit/withdrawal conveyance section 212F, the switching section 212E, and the discharge conveyance section 212G, and discharges the banknotes from the discharge port 212H into the container 12A in sequence. In such cases, only the deposit reject banknotes are contained inside the container 12A.

Moreover, similarly to in the first exemplary embodiment, the banknote control section 211 opens the shutter 12B and displays a specific message on the operation and display section 6 to prompt the customer to check the state of the banknotes and reinsert the banknotes inside the container 12A. The banknote control section 11 then resumes the deposit counting processing.

Sometimes, even though there are still banknotes that have not been taken in (referred to below as non-taken in banknotes) remaining inside the deposit/withdrawal section 212, the conveyance path retention section 22S becomes full and the banknote control section 211 cannot retain any new deposit reject banknotes. In such cases, the banknote control section 211 temporarily interrupts the deposit counting processing and pauses the conveyance of banknotes from the deposit/withdrawal section 212, and conveys all of the deposit reject banknotes retained inside the conveyance path retention section 22S toward the front in sequence, using the temporary holding switching section 20 and the first conveyance section 21 of the conveyance section 13, and conveys the deposit reject banknotes to the deposit/withdrawal section 212 in sequence.

When this is performed, similarly to when verification of all the contained banknotes has been finished, under the control of the banknote control section 211, the deposit/withdrawal section 212 conveys the banknotes received from the conveyance section 13 in sequence using the deposit/withdrawal conveyance section 212F, the switching section 212E, and the discharge conveyance section 212G, and discharges the banknotes in sequence from the discharge port 212H into the container 12A. Note that when this is performed, since the non-taken in banknotes still remain inside the container 12A, the discharged deposit reject banknotes are added at the far rear side of the non-taken in banknotes inside the container 12A, namely are added at the back end of the banknotes arranged in a line.

The banknote control section 211 then resumes take-in of the banknotes from inside the deposit/withdrawal section 212. When this is performed, the banknote control section 211 is capable of prioritizing take-in of the non-taken in banknotes through the take-in port 212C. Accordingly, it is possible to avoid an issue of repeating processing in which, for example, immediately after replacing the deposit reject banknotes in the deposit/withdrawal section 212, the banknote control section 211 takes in the deposit reject banknotes first, such that they become deposit reject banknotes again, and the conveyance path retention section 22S becomes unable to retain any new deposit reject banknotes before the non-taken in banknotes have been taken in, before replacing the deposit reject banknotes in the deposit/withdrawal section 212 once again.

By repeating this processing sequence, the banknote control section 211 is capable of taking in all of the non-taken in banknotes, and ultimately leaving only the deposit reject banknotes inside the container 12A of the deposit/withdrawal section 12. Accordingly, when the banknote deposit/withdrawal device 210 opens the shutter 12B and returns the deposit reject banknotes to the user, it is possible for the user to check and reinsert only the deposit reject banknotes, without mixing in non-taken in banknotes. This thereby enables the checking and reinserting operations that the customer has to perform to be suppressed to a minimum.

In other respects, the banknote deposit/withdrawal device 210 may exhibit similar operation and effects of the banknote deposit/withdrawal device 10 according to the first exemplary embodiment.

According to the above configuration, in the banknote deposit/withdrawal device 210 of the ATM 201 according to the third exemplary embodiment, the mutually independent take-in port 212C and discharge port 212H are respectively disposed at the front and rear of the container 12A in the deposit/withdrawal section 212. This thereby enables the banknote deposit/withdrawal device 210 to prioritize take-in of the unverified banknotes remaining inside the container 12A immediately after replacing the deposit reject banknotes in the deposit/withdrawal section 212 during the deposit counting processing, thereby enabling the number of deposit reject banknotes that the user has to check and reinsert to be suppressed to a minimum.

### 4. Fourth Exemplary Embodiment

An ATM 301 (FIG. 1) according to a fourth exemplary embodiment differs from the ATM 1 according to the first exemplary embodiment in the point that a banknote deposit/withdrawal device 310 is provided in place of the banknote deposit/withdrawal device 10, while being similarly configured in other respects.

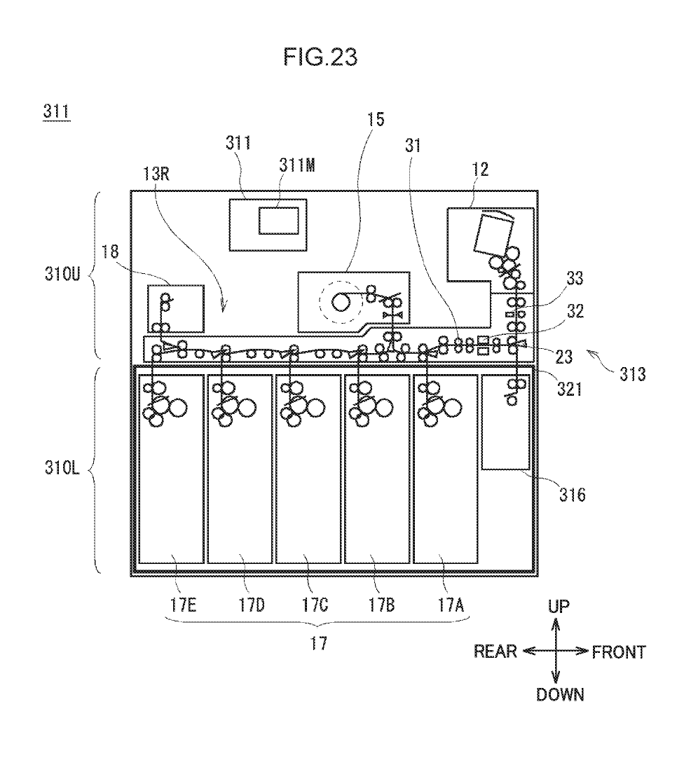

As illustrated in FIG. 23 corresponding to FIG. 2, the banknote deposit/withdrawal device 310 is configured by an upper section block 310U and a lower section block 310L respectively corresponding to the upper section block 10U and the lower section block 10L (FIG. 2) of the first exemplary embodiment. The upper section block 310U is formed with a longer length in the up-down direction and a shorter length in the front-rear direction than in the first exemplary embodiment. The front-rear direction length of the lower section block 310L is formed shorter by a similar amount to the upper section block 310U.

The banknote deposit/withdrawal device 310 differs from the banknote deposit/withdrawal device 10 according to the first exemplary embodiment in the point that a banknote control section 311, a conveyance section 313 and a reject box 316 are provided in place of the banknote control section 11, the conveyance section 13 and the reject box 16, while being similarly configured in other respects.

Similarly to the banknote control section 11 according to the first exemplary embodiment, a banknote control section 311 is configured around a CPU (not illustrated in the drawings), and reads and executes specific programs from ROM (not illustrated in the drawings), flash memory, or the like to perform various processing such as processing to decide banknote conveyance destinations and processing to control operation of the respective sections. In the banknote control section 311, a storage section 311M provided in place of the storage section 11M is stored with various information.

The reject box 316 is formed shorter (namely thinner) in the front-rear direction than the reject box 16 according to the first exemplary embodiment, and has a smaller internal capacity, thereby reducing the number of banknotes that it is capable of housing. Note that although the size of the banknote storage boxes 17 is unchanged from the first exemplary embodiment, the front-rear length of the reject box 316 is reduced, and so the front-rear length of the overall lower section block 310L is reduced.

The conveyance section 313 differs from the conveyance section 13 (FIG. 4) according to the first exemplary embodiment in the point that a first conveyance section 321 is provided in place of the first conveyance section 21, while the second conveyance section 22 and the temporary holding switching section 20 are configured similarly to in the conveyance section 13. The first conveyance section 321 differs from the first conveyance section 21 in parts. Namely, the first conveyance section 321 is configured with a slightly shorter front-rear length, a front end portion is extended upward, and the respective sensors incorporated inside the verification section 14 are installed independently of each other.

Specifically, the run sensor 31 and the image sensor 32 are respectively disposed at similar positions inside the first conveyance section 321 to where they are respectively provided inside the verification section 14 in the first exemplary embodiment. However, the authenticity sensor 33 is disposed where the first conveyance section 321 is extended upward at the front end, namely between the reject switching section 23 and the deposit/withdrawal section 12. In the first conveyance section 321, as a result of disposing the authenticity sensor 33 above the reject switching section 23, the respective distances from the reject switching section 23 to the run sensor 31 and image sensor 32 are shorter than in the first exemplary embodiment.

According to this configuration, during the deposit storage processing, the banknote deposit/withdrawal device 310 is unable to detect the authenticity of a reject banknote with the authenticity sensor 33 when conveying the reject banknote to the reject box 316. However, since the reject banknotes have been detected by the authenticity sensor 33 during conveyance from the deposit/withdrawal section 12 in the earlier deposit counting processing, there is no need to use the authenticity sensor 33 to detect the authenticity again.

Moreover, when conveying banknotes fed out from the banknote storage boxes 17 toward the front during withdrawal processing, the banknote deposit/withdrawal device 310 is unable to use the authenticity sensor 33 to detect the authenticity of banknotes (namely reject banknotes) that have been detected as having overlapping conveyance or the like by the run sensor 31 and are being conveyed to the reject box 316. However, in the banknote deposit/withdrawal device 310, the banknote storage boxes 17 are only loaded with banknotes that have either been detected for authenticity by the authenticity sensor 33 during deposit processing, or have been confirmed to be genuine notes by a member of staff of the financial institution or the like. Accordingly, in the banknote deposit/withdrawal device 310, there is no need to use the authenticity sensor 33 to detect the authenticity of the notes again. Moreover, the banknote deposit/withdrawal device 310 may detect the authenticity of notes conveyed to the deposit/withdrawal section 12 to be withdrawn using the authenticity sensor 33, so there is no possibility of counterfeit notes being incorrectly withdrawn.

In the above configuration, in the banknote deposit/withdrawal device 310 of the ATM 301 according to the fourth exemplary embodiment, the first conveyance section 321 of the conveyance section 313 is configured shorter in the front-rear direction than in the first exemplary embodiment, and is extended upward at the front end. Moreover, in the banknote deposit/withdrawal device 310, the respective sensors that are incorporated together in the verification section 14 in the first exemplary embodiment are disposed independently of each other inside the first conveyance section 321, and in particular, the authenticity sensor 33 is disposed between the reject switching section 23 and the deposit/withdrawal section 12 above.

The banknote deposit/withdrawal device 310 may obtain equivalent verification results of the run sensor 31, the image sensor 32, and the authenticity sensor 33 incorporated into the verification section 14 in the first exemplary embodiment, using the run sensor 31, the image sensor 32, and the authenticity sensor 33 that are disposed independently of each other inside the first conveyance section 321. Accordingly, the banknote deposit/withdrawal device 310 may perform similar deposit counting processing, deposit storage processing, and withdrawal processing to that of the first exemplary embodiment.

Although the banknote deposit/withdrawal device 310 is extended in the up-down direction compared to the banknote deposit/withdrawal device 10 according to the first exemplary embodiment, the front-rear direction can be shortened, this being particularly desirable in cases in which there are heavy constraints on the front-rear direction length at the installation site.

In other respects, the banknote deposit/withdrawal device 310 may exhibit similar operation and effects to the banknote deposit/withdrawal device 10 according to the first exemplary embodiment.

According to the above configuration, in the banknote deposit/withdrawal device 310 of the ATM 301 according to the fourth exemplary embodiment, the first conveyance section 321 is configured in a shape that is shorter in the front-rear direction than the first exemplary embodiment, and is extended upward at the front end, and the run sensor 31, the image sensor 32, and the authenticity sensor 33 are disposed independently of each other inside the first conveyance section 321. The banknote deposit/withdrawal device 310 may enable a reduction in the front-rear length and increased freedom of installation, and may execute deposit counting processing, deposit storage processing, and withdrawal processing similar to that of the first exemplary embodiment.

### 5. Other Exemplary Embodiments

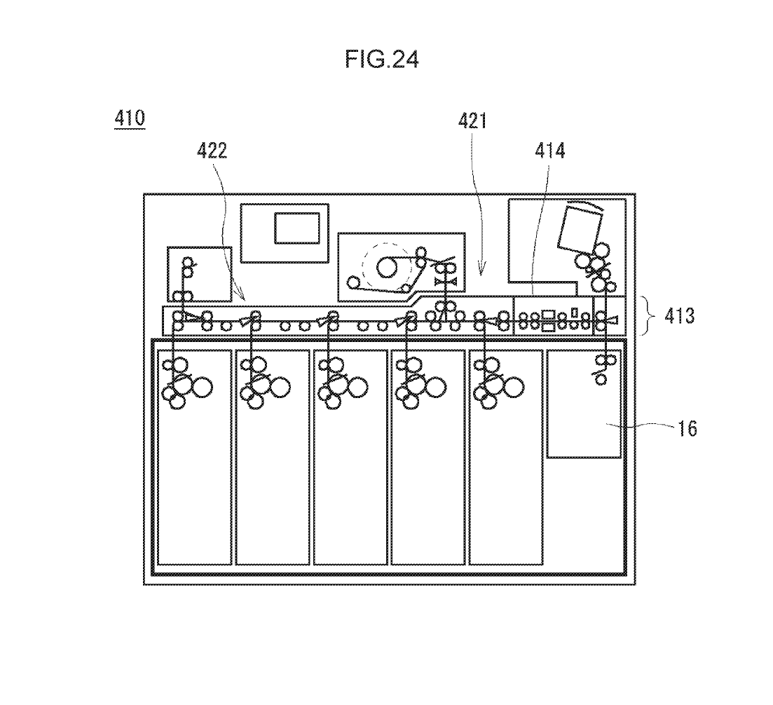

In the first exemplary embodiment described above, explanation has been given regarding a case in which the respective banknote conveyance paths formed inside the first conveyance section 21 and the second conveyance section 22 of the conveyance section 13 are formed so as to meander in the up-down direction on progression along the front-rear direction (for example, FIG. 4). However, the present invention is not limited thereto. For example, as in a banknote deposit/withdrawal device 410 illustrated in FIG. 24 corresponding to FIG. 2, the respective conveyance paths may be formed in straight line shapes inside a first conveyance section 421 and a second conveyance section 422 of a conveyance section 413, and the conveyance paths inside the first conveyance section 421 and the second conveyance section 422 may be parallel to each other. Accordingly, in the banknote deposit/withdrawal device 410 the distance that banknotes are conveyed inside the conveyance section 413 may be reduced, and may enable an accompanying reduction in the occurrence of blockages (referred to as conveyance jams) during banknote conveyance.

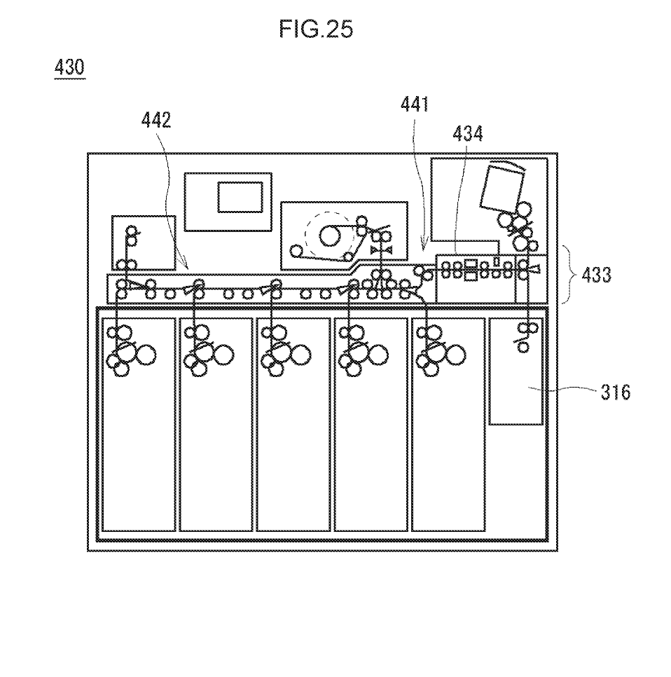

As in a banknote deposit/withdrawal device 430 illustrated in FIG. 25 corresponding to FIG. 24, for example, a banknote conveyance path at the rear of a verification section 434 may be curved in a crank shape, and the main conveyance paths in a first conveyance section 441 and a second conveyance section 442 may be configured parallel to each other. This thereby enables a reduction in the front-rear length of the overall device due to providing the banknote deposit/withdrawal device 430 with the reject box 316 that is shortened in the front-rear direction, similarly to in the fourth exemplary embodiment.

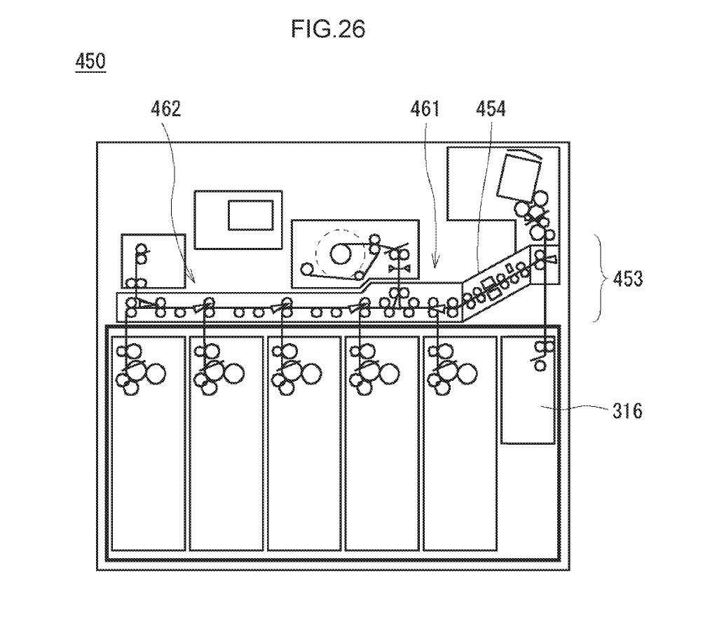

As in a banknote deposit/withdrawal device 450 illustrated in FIG. 26 corresponding to FIG. 24, for example, the main conveyance paths in a second conveyance section 462 may be substantially parallel to each other, and conveyance paths formed inside a first conveyance section 461 and a verification section 454 may be inclined so as to become higher toward the front. This thereby enables a reduction in the front-rear length of the overall device due to providing the banknote deposit/withdrawal device 450 with the reject box 316 that is shortened in the front-rear direction, similarly to in the banknote deposit-withdrawal device 430 illustrated in FIG. 25.

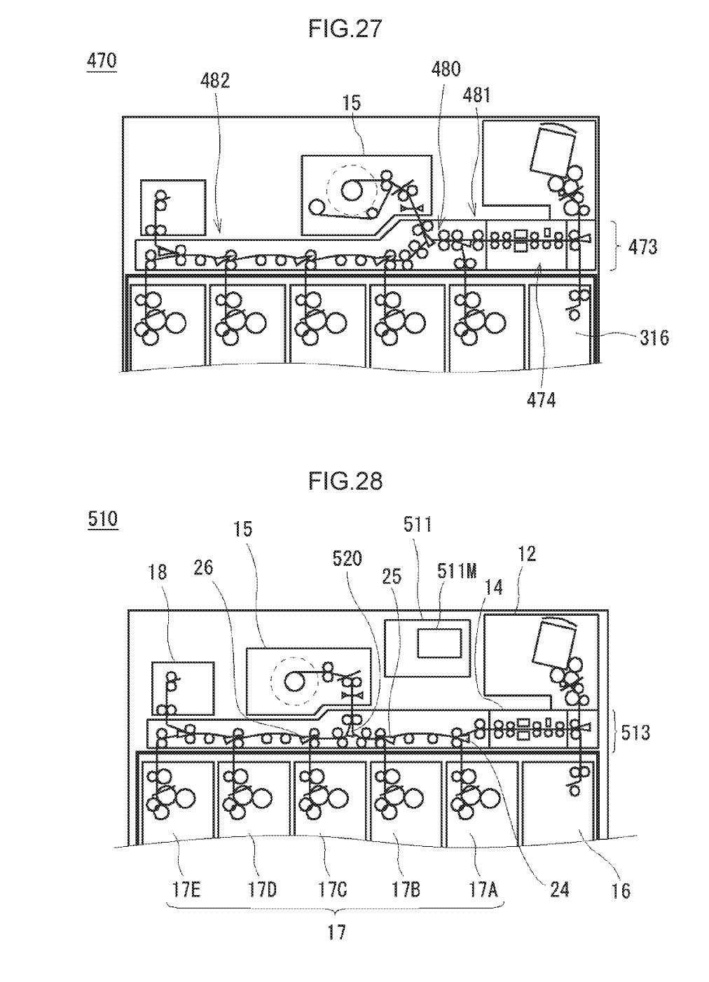

As in a banknote deposit/withdrawal device 470 illustrated in FIG. 27 corresponding to FIG. 24, for example, a conveyance path at a connection location between a temporary holding switching section 480 and a first conveyance section 481 may be configured in a straight line shape, and a conveyance path at a connection location between the temporary holding switching section 480 and a second conveyance section 482 may be inclined, and main conveyance paths in the first conveyance section 481 and the second conveyance section 482 may be configured in straight line shapes. This thereby enables the banknote deposit/withdrawal device 470 to be provided with the reject box 316 that is shortened in the front-rear direction, thereby enabling a reduction in the front-rear length of the overall device similarly to the banknote deposit/withdrawal device 430 illustrated in FIG. 25. Note that in this configuration, the conveyance paths heading in three directions formed by the temporary holding switching section 480 are preferably provided at angles of 120° to one another. However, other angles are also possible.

Namely, in the present invention, it is sufficient that the conveyance section 13 is disposed directly above the plural banknote storage boxes 17 and the reject box 16 that are in a row along the front-rear direction inside the safe casing 10S of the lower section block 10L (FIG. 2), in other words, disposed in a lowermost portion of the upper section block 10U, and that the respective banknote conveyance paths formed inside the first conveyance section 21 and the second conveyance section 22 of the conveyance section 13 are formed substantially along the front-rear direction. In other words, it is sufficient that the conveyance paths inside the conveyance section 13 have a shape in which the respective switching sections connected to the respective sections are connected in series (FIG. 12) rather than in a loop shape (FIG. 16) as hitherto. Namely, it is sufficient that a conveyance path that turns around or reverses the conveyance direction of a banknote is not formed in the temporary holding switching section 20, the first conveyance section 21, and the second conveyance section 22 of the conveyance section 13. Similar also applies to the second to the fourth exemplary embodiments.

In the first exemplary embodiment described above, explanation has been given regarding a case in which the conveyance section 13 is disposed outside the safe casing 10S, more specifically, adjacent to the upper face of the safe casing 10S. However, the present invention is not limited thereto. For example, the conveyance section 13 may be disposed above the banknote storage boxes 17 and the reject box 16, and the conveyance section 13, the banknote storage boxes 17, and the reject box 16 may be provided inside the safe casing 10S. Similar also applies to the second to the fourth exemplary embodiments.

In the first exemplary embodiment described above, explanation has been given regarding a case in which the temporary holding section 15 provided to the banknote deposit/withdrawal device 10 employs what is referred to as tape escrow method, in which banknotes are wrapped onto and stored at the circumferential side face of the drum 41 together with the tape 44. However, the present invention is not limited thereto. The temporary holding sections employing various other methods may be provided to the banknote deposit/withdrawal device 10. In such cases, it is sufficient that, similarly to in the first exemplary embodiment, the temporary holding section is capable of temporarily storing the maximum number of banknotes that could be handled in deposit processing or withdrawal processing (for example, 200 banknotes), and that when feeding out the banknotes, the sequence of the respective banknotes can be preserved in the original sequence or the reverse sequence to when the banknotes were stored. Moreover, it is preferable for the temporary holding section to be capable of feeding out banknotes with their skew and the spacing between the banknotes preserved.

Conveying banknotes fed out from the temporary holding section to the verification section 14, for example, is conceivable in cases in which there is a possibility of being unable to preserve the sequence, skew, and spacing between the respective banknotes due to using a temporary holding section employing a method other than a tape escrow method. The banknotes that pass the verification section 14 are initially conveyed to the deposit/withdrawal section 12 if normal notes (banknotes that can be withdrawn), and other banknotes that are unsuitable for withdrawal (banknotes that are unsuitable for re-cycling) are conveyed to the reject box 16 and stored. Then, the banknotes (normal notes) conveyed to the deposit/withdrawal section 12 are fed out and conveyed again, and after determining the denomination as the banknotes pass the verification section 14, the banknotes are conveyed to the banknote storage boxes 17B to 17E and stored. Banknotes for storage in the banknote storage box 17A may be directly conveyed thereto if the first switching section 124 configured by what is referred to as a three-way blade is employed, as in the second exemplary embodiment. If the first switching section 24 that switches the conveyance path two ways is employed, as in the first exemplary embodiment, the banknotes may be initially conveyed to the temporary holding section, and then conveyed from the temporary holding section. Similar also applies to the second to the fourth exemplary embodiments.

In the first exemplary embodiment described above, explanation has been given regarding a case in which, during the deposit counting processing, the banknote control section 11 associates the denomination, serial number, and conveyance destination, as well as the conveyance state, namely the skew, the spacing between the banknotes, and the like, of each banknote with the banknote conveyance sequence and stores this in the storage section 11M as the information during counting by the verification section 14. However, the present invention is not limited thereto. For example, information during counting may be stored after selectively employing or discarding various information as appropriate based on of the detection results obtained from the respective sensors, for example, employing only the banknote denominations and serial numbers, or only the conveyance state. Similarly, regarding the conveyance state, various information may be selectively employed or discarded as appropriate based on the detection results obtained from the run sensor 31, for example, for example employing only the skew, or only the spacing between banknotes. That is to say, it is sufficient that the conveyance destination can be read, or that the conveyance destination can be decided based on the stored information, during the deposit storage processing. Similar also applied to the conveyance information during storage in the temporary holding section 15, and similar also applies to the second to the fourth exemplary embodiments.

In the first exemplary embodiment described above, explanation has been given regarding a case in which during the deposit counting processing, the conveyance state is detected by the run monitoring sensor 43 during storage of the banknotes in the temporary holding section 15, and the detection results are stored in the storage section 11M as the conveyance information during storage. During the deposit storage processing, the conveyance states obtained from the run monitoring sensor 43 are compared against the conveyance information during storage, and determination is made as to whether or not the conveyance state at the time of storage has been correctly restored. However, the present invention is not limited thereto. For example, in cases in which the temporary holding section 15 is capable of preserving the conveyance state at the time of storage with very high precision, the run monitoring sensor 43 may be omitted, and whether or not the conveyance state has been restored need not be specifically determined. Similar also applies to the second to the fourth exemplary embodiments.

In the first exemplary embodiment described above, during the deposit storage processing, in cases in which determination is made that the conveyance state at the time of storage has not been correctly restored in a banknote fed out from the temporary holding section 15, the banknote is re-verified by the verification section 14 partway through being conveyed to the reject box 16 by the first conveyance section 21. In cases in which there is a match with the information during counting stored in the storage section 11M, the conveyance destination decided during the deposit counting processing is employed. However, the present invention is not limited thereto. For example, during the deposit storage processing, in cases in which determination is made that the conveyance state at the time of storage has not been correctly restored in a banknote fed out from the temporary holding section 15, the banknote may be automatically conveyed to the reject box 16 irrespective of the result of re-verification by the verification section 14. Similar also applies to the second to the fourth exemplary embodiments.

In the first exemplary embodiment described above, explanation has been given regarding a case in which, specifically, the spacing between the banknotes and the skew of each banknote (namely the angle with respect to the conveyance direction) are detected as the banknote conveyance state by the run monitoring sensor 43 of the temporary holding section 15. However, the present invention is not limited thereto. For example, either one out of the spacing between the banknotes and the skew of each banknote, or the banknote thickness, may be detected, or an appropriate combination of these may be employed. Similar also applies to the second to the fourth exemplary embodiments.

In the first exemplary embodiment described above, explanation has been given regarding a case in which, during the deposit counting processing, the information during counting from the verification section 14, and the conveyance information during storage from the run monitoring sensor 43, are stored in the storage section 11M of the banknote control section 11. However, the present invention is not limited thereto. For example, the information during counting and the conveyance information during storage may be stored in various locations capable of storing information, for example in a storage section 9M of the main control section 9, or in a storage section provided inside an external server device connected through a specific network (not illustrated in the drawings). Similar also applies to the second to the fourth exemplary embodiments.

In the first exemplary embodiment described above, explanation has been given regarding a case in which deposit reject banknotes are retained in the conveyance path retention section 22S of the second conveyance section 22, and, after all of the banknotes in the deposit/withdrawal section 12 have been verified by the verification section 14, the first conveyance section 21 is driven back in the opposite direction to convey the deposit reject banknotes to the deposit/withdrawal section 12. However, the present invention is not limited thereto. For example, take-in of banknotes from the deposit/withdrawal section 12 may be interrupted each time a deposit reject banknote is detected by the verification section 14, and the first conveyance section 21 may be temporarily driven back in the opposite direction to convey the deposit reject banknote to the deposit/withdrawal section 12. In such cases, there is no need to employ the second conveyance section 22 as the conveyance path retention section 22S. Similar also applies to the second to the fourth exemplary embodiments.

In the first exemplary embodiment described above, explanation has been given regarding a case in which, when the conveyance path retention section 22S becomes full during execution of deposit counting processing during a deposit transaction, the deposit counting processing is temporarily interrupted and all of the reject banknotes from the conveyance path retention section 22S are conveyed back in the opposite direction to the deposit/withdrawal section 12 in sequence, before resuming the deposit counting processing. However, the present invention is not limited thereto, and, for example, in addition to processing in which the verification section 14 verifies the banknotes taken in one note at a time from the deposit/withdrawal section 12, the deposit counting processing may also include processing to convey all of the reject banknotes back in the opposite direction to the deposit/withdrawal section 12 in sequence in cases in which the conveyance path retention section 22S becomes full. Similar also applies to the second to the fourth exemplary embodiments.

In the first exemplary embodiment described above, explanation has been given regarding a case in which deposit reject banknotes are retained in the conveyance path retention section 22S of the second conveyance section 22. However, the present invention is not limited thereto. For example, various locations within the banknote deposit/withdrawal device 10 that are capable of retaining banknotes, for example the banknote storage box 17E, may be employed as temporary storage boxes for the deposit reject banknotes. In such cases, using the verification section 14 to verify all of the banknotes in the deposit/withdrawal section 12, all of the deposit reject banknotes stored in the banknote storage box 17E may be conveyed to the deposit/withdrawal section 12 and returned to the customer. Similar also applies to the second to the fourth exemplary embodiments.

In the first exemplary embodiment described above, explanation has been given regarding a case in which the spacing between the banknotes is shortened from the conveyance spacing V1 to the retention spacing V2 when retaining deposit reject banknotes in the conveyance path retention section 22S of the second conveyance section 22 (FIG. 3A, FIG. 3B). However, the present invention is not limited thereto. For example, in cases in which the conveyance path in the second conveyance section 22 is relatively long, the conveyance spacing V1 from the first conveyance section 21 may be preserved as it is during retention, without shortening the spacing between the banknotes. In such cases, it is sufficient to rotate the respective rollers and the like in the second conveyance section 22 at a uniform rotation speed, similarly to the rotation of the respective rollers and the like in the first conveyance section 21. Similar also applies to the second to the fourth exemplary embodiments.

In the first exemplary embodiment described above, explanation has been given regarding a case in which the banknote control section 11 identifies the position of a rear edge of the deposit reject banknotes retained inside the conveyance path retention section 22S based on control signals and the like of the motor M2 (FIG. 4) that drives the respective rollers of the second conveyance section 22. However, the present invention is not limited thereto. For example, in cases in which the control precision of the motor M2 is relatively low, an optical sensor may be provided in the vicinity of a rear end of the inside of the second conveyance section 22, and the banknote control section 11 may identify the position of the rear edge of the deposit reject banknote retained inside the conveyance path retention section 22S based on a detection result of the banknote from this optical sensor. Similar also applies to the second to the fourth exemplary embodiments.

In the first exemplary embodiment described above, explanation has been given regarding a case in which the installation positions of the motors M1 and M2 are in the vicinity of the respective rollers to which their respective drive force is transmitted, namely inside the first conveyance section 21 and the second conveyance section 22. However, the present invention is not limited thereto. For example, the motor M2 may be disposed at any location, for example, inside the first conveyance section 21 or outside the conveyance section 13, and drive force from the motor M2 may be transmitted to the respective rollers inside the second conveyance section 22 through gears and the like (not illustrated in the drawings). Moreover, the motor M2 may be omitted, and an appropriate combination of a clutch mechanism (not illustrated in the drawings) or gears with different numbers of teeth to each other, for example, may be employed to transmit drive force from the motor M1 to the respective rollers inside the first conveyance section 21 and to the respective rollers inside the second conveyance section 2 to control the conveyance speeds of banknotes inside the first conveyance section 21 and inside the second conveyance section 22 independently of each other. Similar also applies to the motor M1, and similar also applies to the second to the fourth exemplary embodiments.

In the first exemplary embodiment described above, explanation has been given regarding a case in which no particular distinction is made when banknotes are contained inside the container 12A of the deposit/withdrawal section 12. However, the present invention is not limited thereto. For example, a partitioning plate that is capable of moving in the front-rear direction may be provided inside the container 12A, and during the deposit counting processing, unverified banknotes may be positioned in front of the partitioning plate, and deposit reject banknotes may be positioned behind the partitioning plate. Similar also applies to the second to the fourth exemplary embodiments.

In the first exemplary embodiment described above, explanation has been given regarding a case in which, when the conveyance destination of a banknote is decided as the reject box 16 during withdrawal processing, the conveyance operation is varied according to which sensor the detection result came from. Specifically, in cases in which the conveyance destination of the banknote was decided as the reject box 16 based on the detection result from the run sensor 31, a switching operation of the conveyance path by the reject switching section 23 is completed before the banknote reaches the reject switching section 23. However, in cases in which the conveyance destination of the banknote was decided as the reject box 16 based on the detection result from the image sensor 32 or the authenticity sensor 33, the banknote is conveyed back in the opposite direction to the rear of the reject switching section 23 after the banknote has passed the reject switching section 23, and then the conveyance path is switched by the reject switching section 23. However, the present invention is not limited thereto. For example, in cases in which the conveyance path from the image sensor 32 and the authenticity sensor 33 to the reject switching section 23 is relatively long, the switching operation of the conveyance path may be completed before the banknote reaches the reject switching section 23, regardless of which sensor the detection result came from when deciding on the reject box 16 as the conveyance destination of the banknote. Similar also applies to the second and third exemplary embodiments.

In the first exemplary embodiment described above, explanation has been given regarding a case in which the run sensor 31 is configured by a thickness sensor and an optical sensor, and the presence of overlapping conveyance, the skew of each banknote, and the spacing between the banknotes are identified by the banknote control section 11 based on the respective detection results. However, the present invention is not limited thereto, Run sensors may be configured by sensors of various other types. That is to say, it is sufficient that detection can be made as to whether or not each banknote is a deposit reject banknote during the deposit counting processing, and that detection can be made as to whether or not each banknote is a reject banknote during withdrawal processing. Similar also applies to the second to the fourth exemplary embodiments.

In the first exemplary embodiment described above, explanation has been given regarding a case in which the temporary holding switching section 20 that switches the conveyance path to convey banknotes from the conveyance section 13 to the temporary holding section 15 is disposed between the first switching section 24 and the second switching section 25, and the temporary holding switching section 20 splits the conveyance section 13 into the first conveyance section 21 on the front side, and the second conveyance section 22 on the rear side. However, the present invention is not limited thereto. The temporary holding switching section 20 may be disposed at another location inside the conveyance section 13. For example, as in a banknote deposit/withdrawal device 510 illustrated in FIG. 28 corresponding to FIG. 2, a temporary holding switching section 520 may be disposed between the second switching section 25 and the third switching section 26 in a conveyance section 513, such that the temporary holding switching section 520 splits the conveyance section 513 into a first conveyance section 521 on the front side, and a second conveyance section 522 on the rear side.

In the banknote deposit/withdrawal device 510, although the front-rear length of the second conveyance section 522 is shortened, thereby reducing the number of deposit reject banknotes that can be retained in a conveyance path retention section 522S, the spacing between the verification section 14 and the temporary holding switching section 520 becomes longer. Accordingly, during the deposit counting processing in the banknote deposit/withdrawal device 510, the amount of time leeway to switch the conveyance path with the temporary holding switching section 520 based on the detection results of the respective sensors in the verification section 14 can be increased. For example, handled banknotes with a relatively long length along the conveyance direction (namely the short edge direction) can also be accommodated. Similar also applies to the second to the fourth exemplary embodiments.

In the first exemplary embodiment described above, explanation has been given regarding a case in which the conveyance section 13 is broadly configured split into the first conveyance section 21, the temporary holding switching section 20, and the second conveyance section 22. However, the present invention is not limited thereto. For example, the conveyance section 13 may be split into plural parts in various ways, or the conveyance section 13 may be configured as one part, without being split. However, it is desirable that as a minimum, respective rollers for conveying banknotes at the front side of the temporary holding switching section 20, and respective rollers for conveying banknotes at the rear side of the temporary holding switching section 20 can be driven independently of each other. This thereby enables the conveyance section to retain only deposit reject banknotes in sequence in the conveyance path retention section 22S, while conveying normal banknotes in sequence to the temporary holding section 15, and also enables the spacing between deposit reject banknotes retained in the conveyance path retention section 22S to be compressed when both parts of the conveyance section are driven at different speeds to each other. Similar also applies to the second to the fourth exemplary embodiments.

In the first exemplary embodiment described above, explanation has been given regarding a case in which, during withdrawal processing, the banknote control section 11 decides the conveyance destination of each banknote to be the deposit/withdrawal section 12 or the reject box 16 based on only the detection result from the run sensor 31 of the verification section 14. However, the present invention is not limited thereto. For example, during withdrawal processing, the banknote control section 11 may decide the conveyance destination of each banknote based on the detection results of various sensors. For example, the banknote control section 11 may decide the conveyance destination of each banknote based on the detection results of both the run sensor 31 and the image sensor 32. That is to say, in such cases, it is sufficient that the banknote control section 11 is capable of deciding the conveyance destination based on the detection results obtained from the respective sensors, and that the switching operation of the conveyance path by the reject switching section 23 can be completed, between each banknote being detected by the respective sensors and the banknote being conveyed forward far enough to reach the reject switching section 23. Similar also applies to the second to the fourth exemplary embodiments.

In the first exemplary embodiment described above, explanation has been given regarding a case in which the verification section 14 is provided with three types of sensor, namely the run sensor 31, the image sensor 32, and the authenticity sensor 33. However, the present invention is not limited thereto, and the verification section 14 may be provided with two types of sensor or fewer, or with four or more types of sensor. That is to say, as a minimum, it is sufficient that during the deposit counting processing, based on the obtained detection results, the banknote control section 11 is capable of determining whether each banknote is a normal banknote or a deposit reject banknote, and of deciding the conveyance destination in the subsequent deposit storage processing. Similar also applies to the second to the fourth exemplary embodiments.

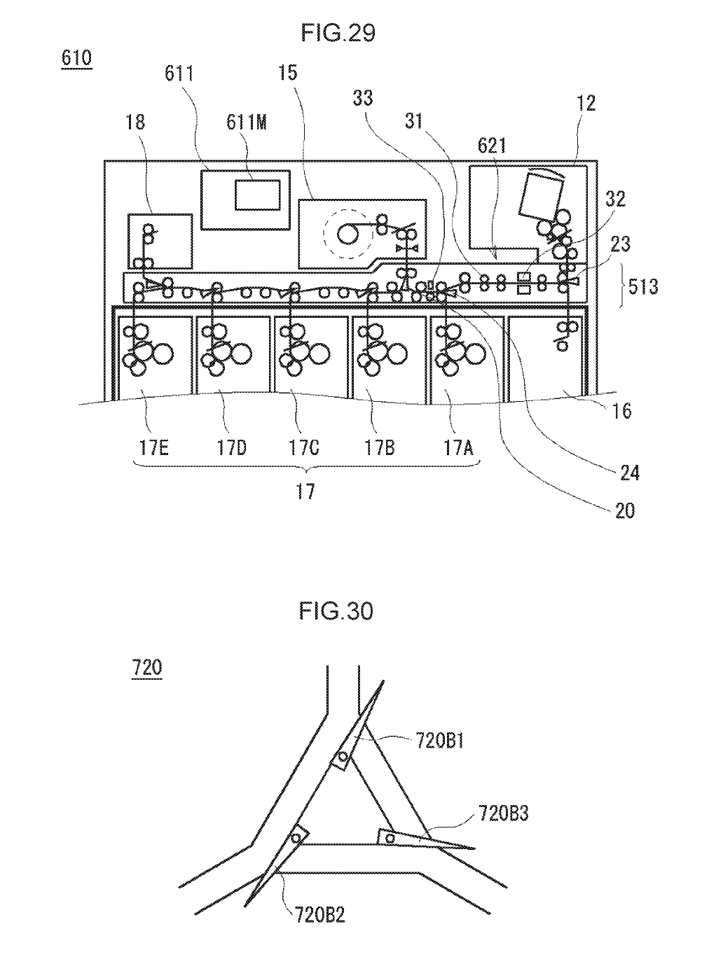

In the fourth exemplary embodiment described above, explanation has been given regarding a case in which the verification section 14 is not provided inside the first conveyance section 321 (FIG. 23), and the run sensor 31, the image sensor 32, and the authenticity sensor 33 are respectively disposed independently of each other, the run sensor 31 and the image sensor 32 are disposed between the first switching section 24 and the reject switching section 23, and the authenticity sensor 33 is disposed between the reject switching section 23 and the deposit/withdrawal section 12. However, the present invention is not limited thereto, and, the respective sensors may be disposed in various locations. For example, the run sensor 31 may be disposed between the first switching section 24 and the reject switching section 23, and the image sensor 32 and the authenticity sensor 33 may be disposed between the reject switching section 23 and the deposit/withdrawal section 12. Moreover, for example, as in a banknote deposit/withdrawal device 610 illustrated in FIG. 29 corresponding to FIG. 2 and FIG. 23, the authenticity sensor 33 may be disposed at the rear of the first switching section 24 inside a first conveyance section 621.

In the banknote deposit/withdrawal device 610, the authenticity sensor 33 is at a very close distance to the temporary holding switching section 20, and so there is not enough time for the temporary holding switching section 20 to switch the conveyance destination of a conveyed banknote based on the result detected by the authenticity sensor 33 during the deposit counting processing. However, in the banknote deposit/withdrawal device 610, detection results from the authenticity sensor 33 for the respective banknotes stored in the temporary holding section 15 can be stored in a storage section 611M, thereby enabling the conveyance path to be switched to convey counterfeit notes to the counterfeit note box 18 based on the stored detection results during the subsequent deposit storage processing.

In the first exemplary embodiment described above, explanation has been given regarding a case in which the temporary holding switching section 20 that switches the conveyance path three ways changes the angle of inclination of the single blade 20B to switch the banknote conveyance direction using what is referred to as three-way blade method. However, the present invention is not limited thereto. For example, as in a temporary holding switching section 720 illustrated in FIG. 30, the conveyance path may be switched three ways using a combination of three blades 720B 1, 720B2, and 720B3.

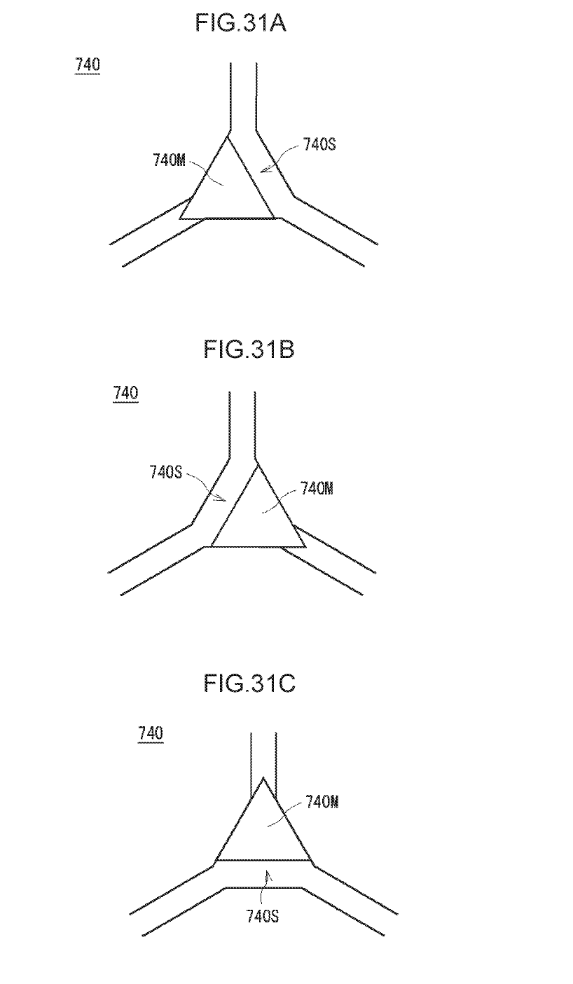

Moreover, as in a temporary holding switching section 740 illustrated in FIG. 31A to FIG. 31C, the conveyance path may be switched three ways by moving a moving body 740M that is formed in a triangular prism shape slightly smaller than the inside of a movement space 740S formed in a triangular shape as viewed from the left or right side. Namely, the temporary holding switching section 20 may employ various methods capable of switching the conveyance path three ways. Similar also applies to the second to the fourth exemplary embodiments, and in particular, similar also applies to the first switching section 124 of the second exemplary embodiment.

In the first exemplary embodiment described above, explanation has been given regarding a case in which the reject box 16 and the counterfeit note box 18 are provided inside the banknote deposit/withdrawal device 10. However, the present invention is not limited thereto. For example, either or both the reject box 16 and the counterfeit note box 18 may be omitted. In such cases, any one out of the five banknote storage boxes 17 (17A to 17E) may be employed to store reject banknotes or counterfeit notes. Similar also applies to the second to the fourth exemplary embodiments. In particular, in the second exemplary embodiment, for example, since the first switching section 124 employs what is referred to as a three-way blade method, setting the banknote storage box 17A as a counterfeit note box enables deposited counterfeit notes to be immediately conveyed to the banknote storage box 17A.

In the first exemplary embodiment described above, explanation has been given regarding a case in which counterfeit notes, namely banknotes that have been determined to be counterfeit notes based on the verification results from the verification section 14, are stored in the counterfeit note box 18 (FIG. 2) positioned at the upper rear side of the second conveyance section 22. However, the present invention is not limited thereto. For example, in cases in which the customer forgets to take their banknotes out of the deposit/withdrawal section 12 in a withdrawal transaction, these banknotes (referred to as forgotten banknotes) may be conveyed to the counterfeit note box 18 and stored. The counterfeit note box 18 is provided inside the upper section block 10U, rather than being provided inside the safe casing 10S like the lower section block 10L. Accordingly, in cases in which the customer realizes that they have forgotten and comes back, for example, the forgotten banknotes can be immediately taken out of the counterfeit note box 18 and handed to the customer even by a general member of staff with low level security clearance who does not have access rights to the inside of the safe casing 10S. Similar also applies to the second to the fourth exemplary embodiments.

In the first exemplary embodiment described above, explanation has been given regarding a case in which the reject box 16 is connected to the first conveyance section 21 through the reject switching section 23 (FIG. 4. FIG. 12). However, the present invention is not limited thereto. For example, a second reject box for storing reject banknotes may be connected to the second conveyance section 22 through a specific second reject switching section. The second reject box may be disposed either inside the upper section block 10U or inside the lower section block 10L. Similar also applies to the second to the fourth exemplary embodiments.

In the first exemplary embodiment described above, explanation has been given regarding a case in which the reject switching section 23 employs what is referred to as a two-way blade method that has a configuration that switches two ways, namely between the conveyance path linking the deposit/withdrawal section 12 at the upper side to the verification section 14 at the rear side, and the conveyance path linking the verification section 14 at the rear side to the reject box 16 at the lower side.

However, the present invention is not limited thereto. For example, the reject switching section may employ similar configuration to that of the temporary holding switching section 20, namely a three-way blade method. In such cases, the reject switching section is capable of forming a new conveyance path linking the deposit/withdrawal section 12 to the reject box 16. Accordingly, in cases in which the reject box 16 is employed as a location for storing recovered forgotten banknotes that a customer has forgotten to take from the deposit/withdrawal section 12, for example, it is possible to convey the forgotten banknotes directly from the deposit/withdrawal section 12 to the reject box 16. This thereby enables the conveyance processing to be completed in a short time, enabling subsequent new transactions to be resumed swiftly. Moreover, in such cases, due to forming a conveyance path linking the deposit/withdrawal section 12 and the reject box 16 directly, in the withdrawal processing described above, when the image sensor 32 and the authenticity sensor 33 have detected banknotes unsuitable for withdrawal, the banknotes can be conveyed directly to the reject box 16, without conveying the banknotes back in the opposite direction to the verification section 14. This thereby enables withdrawal processing to be completed in a short time in cases in which banknotes that are unsuitable for withdrawal arise, and also enables the occurrence of collisions between a banknote and following banknotes when being conveyed back in the opposite direction, banknote blockages, and the like to be suppressed. Similar also applies to the second to the fourth exemplary embodiments.

In the third exemplary embodiment described above, explanation has been given regarding a case in which when, the conveyance path retention section 22S becomes unable to retain any more deposit reject banknotes while non-taken in banknotes still remain inside the deposit/withdrawal section 212 during the deposit counting processing, after conveying the deposit reject banknotes to the deposit/withdrawal section 212 and housing the deposit reject banknotes at the rear side of the non-taken in banknotes, take-in of the banknotes is resumed with the shutter 12B remaining closed. However, the present invention is not limited thereto. For example, after conveying the deposit reject banknotes to the deposit/withdrawal section 212 and housing the deposit reject banknotes at the rear side of the non-taken in banknotes, the shutter 12B may be opened to prompt the customer to take out, check, and reinsert the deposit reject banknotes together with the non-taken in banknotes. Unnecessary processing, in which the same banknotes are repeatedly verified only to be verified as deposit reject banknotes each time and passed back and forth repeatedly between the conveyance path retention section 22S and the deposit/withdrawal section 212, may be avoided in such cases.

In the first exemplary embodiment described above, explanation has been given regarding a case in which the five banknote storage boxes 17 (17A to 17E) are provided in the banknote deposit/withdrawal device 10. However, the present invention is not limited thereto, and four or fewer of the banknote storage boxes 17, or six or more of the banknote storage boxes 17, may be provided. For example, in cases in which three of the banknote storage boxes 17 are provided, the front-rear length of the ATM 1 can be greatly reduced, this being desirable in cases in which in which the ATM 1 is installed in a location with a limited installation area, such as in a convenience store. Similar also applies to the second to the fourth exemplary embodiments.

In the first exemplary embodiment described above, explanation has been given regarding a case in which peripheral side faces of the lower section block 10L are covered by the safe casing 10S. However, the present invention is not limited thereto. For example, a large safe casing 10S may be provided so as to cover both the lower section block 10L and the upper section block 10U, or the safe casing 10S may be omitted. Similar also applies to the second to the fourth exemplary embodiments.

In the first exemplary embodiment described above, explanation has been given regarding a case in which the detection results of the respective sensors of the verification section 14 are sent to the banknote control section 11, and the banknote control section 11 decides the conveyance destination after identifying the denomination, authenticity, level of damage, and the like of a banknote. However, the present invention is not limited thereto. For example, the verification section 14 may be provided with a dedicated verification control section, and the detection results of the respective sensors of the verification section 14 may be sent to the verification control section for the verification control section to identify the denomination, authenticity, level of damage, and the like of a banknote. In such cases, information expressing the denomination, authenticity, level of damage, and the like identified by the verification control section may be sent to the banknote control section 11 for the banknote control section 11 to decide the banknote conveyance destination. This thereby enables a reduction in the processing load of the banknote control section 11. Similar also applies to the second to the fourth exemplary embodiments.

In the first exemplary embodiment described above, explanation has been given regarding a case in which both the banknote storage boxes 17 and the reject box 16 are detachable with respect to the lower section block 10L, and the banknote storage boxes 17 and the reject box 16 have mutually interchangeable structures. However, the present invention is not limited thereto. For example, at least one out of the banknote storage boxes 17 or the reject box 16 may have a structure that is fixed to the lower section block 10L, or the banknote storage boxes 17 and the reject box 16 may have structures that are not mutually interchangeable. Similar also applies to the second to the fourth exemplary embodiments.

In the first exemplary embodiment described above, explanation has been given regarding a case in which the banknote control section 11 of the banknote deposit/withdrawal device 10 executes various processing such as deposit counting processing, deposit storage processing, and withdrawal processing. However, the present invention is not limited thereto, and, the respective processing may, for example, be executed by the main control section 9 (FIG. 1) of the ATM 1, or by the main control section 9 and the banknote control section 11 working together with each other. Similar also applies to the second to the fourth exemplary embodiments.

In the first exemplary embodiment described above, explanation has been given regarding a case in which the present invention is applied to the banknote deposit/withdrawal device 10 of the ATM 1 that performs transaction processing relating to banknotes, serving as a medium, with a customer. However, the present invention is not limited thereto. For example, the present invention may be applied to various devices that handle various paper sheet shaped media such as various cash vouchers or securities, or entrance tickets or passenger tickets. Similar also applies to the second to the fourth exemplary embodiments.

The present invention is not limited to the respective exemplary embodiments described above nor to the other exemplary embodiments described above. Namely, the present invention encompasses application to exemplary embodiments appropriately combining some or all of the respective exemplary embodiments described above and the other exemplary embodiments described above, and exemplary embodiments deriving from elements thereof.

In the exemplary embodiments described above, explanation has been given regarding cases in which the banknote deposit/withdrawal device 10 serving as a medium processing device, and the ATM 1, serving as a medium transaction device, are respectively configured by the deposit/withdrawal section 12 serving as an input/output section, the first conveyance section 21 serving as a first conveyance section, the verification section 14 serving as a verification section, the storage section 11M serving as a storage section, the temporary holding switching section 20 serving as a temporary holding switching section, the temporary holding section 15 serving as a temporary holding section, the second conveyance section 22 serving as a second conveyance section, the banknote storage boxes 17 serving as medium storage boxes, the reject box 16 serving as a reject box, and the banknote control section 11 serving as a control section.

However, the present invention is not limited thereto, and a medium processing device and a medium transaction device may be configured by input/output sections, first conveyance sections, verification sections, storage sections, temporary holding switching sections, temporary holding sections, second conveyance sections, medium storage boxes, reject boxes, and control sections of various other configurations.

(1) Further, a medium processing device includes: an input/output section that inputs or outputs a paper sheet shaped medium; a first conveyance section, connected to the input/output section, that conveys the medium, a verification section, provided to the first conveyance section, that verifies the conveyed medium; a temporary holding switching section, connected to the first conveyance section at the opposite side from the input/output section and with the verification section thereinbetween, that switches a conveyance path of the medium; a temporary holding section, connected to the first conveyance section through the temporary holding switching section, that stores the medium temporarily, and that feeds out the medium in the same sequence or in a reverse sequence to when the medium was stored; a second conveyance section, connected to either the temporary holding section or the first conveyance section through the temporary holding switching section, that conveys the medium; a medium storage box, connected to the second conveyance section, that stores reusable medium; a reject box, connected to either the first conveyance section or the second conveyance section through a reject switching section, that stores any rejected medium that has been verified in the verification section as unsuitable for reuse; and a control section that employs a verification result of the verification section to control a conveyance path of the medium configured by the first conveyance section, the temporary holding switching section, and the second conveyance section.

Accordingly, in the banknote deposit/withdrawal device 10, during the deposit counting processing, banknotes taken in from the deposit/withdrawal section 12 are stored in sequence in the temporary holding section 15 while undergoing verification by the verification section 14. Thereafter, during the deposit storage processing, the banknotes are fed out from the temporary holding section 15 in the reverse sequence to when being stored, and are conveyed by the temporary holding switching section 20, the first conveyance section 21, and the second conveyance section 22 to a conveyance destination based on the verification results obtained during the deposit counting processing. Accordingly, appropriate storage in the banknote storage boxes 17 or the reject box 16 without performing re-verification is enabled. Namely, in the banknote deposit/withdrawal device 10, the conveyance path of the conveyance section 13 is configured in a straight line shape rather than a loop shape, while employing a configuration capable of performing appropriate deposit counting processing. Accordingly, the banknote deposit/withdrawal device 10 may enable a simpler configuration than hitherto, may reduce the size and the number of components, and may also reduce the frequency of breakdowns and amount of work required in maintenance operations.

(2) Further, in (1), the medium processing device may further include a storage section that stores a verification result of the verification section, wherein, during acceptance processing to accept the medium from outside through the input/output section, the control section may use the first conveyance section to convey the medium from the input/output section to the temporary holding section through the verification section, and may store in the storage section verification results by the verification section for each of the respective medium, and according to the verification results stored in the storage section for the medium, may feed the medium out from the temporary holding section and may convey the medium to either the medium storage box or to the reject box.

Accordingly, in the banknote deposit/withdrawal device 10, during the deposit counting processing, banknotes are stored in sequence in the temporary holding section 15 while storing the information during counting expressing the verification results of verification by the verification section 14 in the storage section 11M. During the later deposit storage processing, the banknotes fed out from the temporary holding section 15 in the reverse sequence to that during storage are conveyed to a conveyance destination based on the information during counting stored in the storage section 11M. This thereby enables appropriate storage in the banknote storage boxes 17 or the reject box 16 without performing re-verification.

(3) Further, the medium processing device, in the above described (2), the second conveyance section may include at least a portion of the conveyance path of the medium as a conveyance path retention section that temporarily retains the medium; and the control section may control the temporary holding switching section such that a reject medium that has been conveyed by the first conveyance section and determined in the verification section as medium unsuitable for acceptance into the device is conveyed to the second conveyance section and retained in the conveyance path retention section, and at least one part of other mediums are conveyed to and stored in the temporary holding section.

Accordingly, in the banknote deposit/withdrawal device 10, there is no need to return a deposit reject banknote to the deposit/withdrawal section 12 each time a deposit reject banknote arises, thus enabling processing to take in banknotes from the deposit/withdrawal section 12 and store normal banknotes in sequence in the temporary holding section 15 to be performed continuously. Accordingly, the banknote deposit/withdrawal device 10 may, for example, shorten amount of time for the deposit counting processing to be completed, than in cases in which take-in and conveyance of banknotes is interrupted and a deposit reject banknote is returned to the customer each time a deposit reject banknote arises.

(4) Further, the medium processing device, in the above described (3), the first conveyance section may convey the medium with an inter-medium spacing set to a specific conveyance spacing, and, when passing the reject medium from the first conveyance section to the second conveyance section through the temporary holding switching section, the control section may reduce the inter-medium spacing to a retention spacing that is shorter than the conveyance spacing.

The banknote deposit/withdrawal device 10 accordingly enables the spacing between the banknotes being conveyed through the verification section 14 in the first conveyance section 21 to be set to the relatively wide conveyance spacing V1, enabling appropriate verification by the verification section 14 distinguishing the respective banknotes one note at a time, and enables the spacing between banknotes in the conveyance path retention section 22S of the second conveyance section 22 to be set to the relatively narrow retention spacing V2, enabling storage of as many deposit reject banknotes as possible.

(5) Further, the medium processing device, in the above described (4), when passing the reject medium from the first conveyance section to the second conveyance section through the temporary holding switching section, the control section may intermittently convey the medium in the second conveyance section.

Accordingly, in the banknote deposit/withdrawal device 10, by rotating the respective rollers of the first conveyance section 21 continuously and rotating the respective rollers of the second conveyance section 22 intermittently, the spacing between the banknotes can be reduced from the conveyance spacing V1 to the retention spacing V2 when passing deposit reject banknotes from the first conveyance section 21 to the second conveyance section 22.

(6) Further, the medium processing device, in the above described (3), the control section may use the first conveyance section to convey the reject medium retained in the conveyance path retention section to the input/output section after all of the medium has been conveyed from the input/output section and verified by the verification section.

Accordingly, in the banknote deposit/withdrawal device 10, since deposit reject banknotes stored in the conveyance path retention section 22S can be conveyed to the deposit/withdrawal section 12 by the first conveyance section 21 and returned to the customer, there is no need to provide a return conveyance path, enabling simpler conveyance paths than in the conventional banknote deposit/withdrawal device 810 (FIG. 32).

(7) Further, the medium processing device, in the above described (3), in cases in which no new reject medium can be retained in the conveyance path retention section, the control section may interrupt conveyance of the new medium from the input/output section, and may use the first conveyance section to convey all of the reject media being retained in the conveyance path retention section to the input/output section.

Accordingly, in the banknote deposit/withdrawal device 10, the conveyance path retention section 22S can be returned to an empty state, thereby enabling storage in the conveyance path retention section 22S if new deposit reject banknotes arise in a state in which the conveyance path retention section 22S had become full. This thereby enables continuation of transaction processing with a customer.

(8) Further, the medium processing device, in the above described (3), may further include: a counterfeit medium storage box that stores a counterfeit medium that is a medium verified as counterfeit by the verification section; and a counterfeit medium switching section that connects the counterfeit medium storage box to the second conveyance section, wherein, in cases in which the medium has been verified as the counterfeit medium by the verification section, the control section may use the first conveyance section to convey and store the counterfeit medium in the temporary holding section, and then may use the second conveyance section to convey the counterfeit medium to the counterfeit medium storage box.

Accordingly, in the banknote deposit/withdrawal device 10, normal banknotes and counterfeit notes can be stored in the temporary holding section 15 during the deposit counting processing, thereby enabling the normal notes to be stored in the banknote storage boxes 17, and the counterfeit notes to be stored in the counterfeit note box 18 through the second conveyance section 22 during the subsequent deposit storage processing.

(9) Further, the medium processing device, in the above described (2), the temporary holding section may include a temporary holding detection section that detects a conveyance state of the medium, and the control section may control a conveyance path of the medium according to a conveyance state at the time of storing the medium in the temporary holding section, and a conveyance state at the time of feeding out the medium from the temporary holding section.

The banknote deposit/withdrawal device 10 accordingly enables appropriate determination to be made as to whether each banknote should be conveyed to either the banknote storage boxes 17 or the reject box 16, according to any difference between the conveyance state when storing the banknotes in the temporary holding section 15 and the conveyance state when feeding out the banknote from the temporary holding section 15. Namely, in the banknote deposit/withdrawal device 10, during the deposit storage processing, each banknote can be appropriately stored without passing the verification section 14, thereby enabling simpler conveyance paths than in the conventional banknote deposit/withdrawal device 810 (FIG. 32).

(10) Further, the medium processing device, in the above described (9), the storage section may store a detection result of the temporary holding detection section as a conveyance state during storage, and in cases in which a conveyance state of the medium detected by the temporary holding detection section during feed-out from the temporary holding section differs from the conveyance state during storage being stored in the storage section, the control section may convey the medium and the following medium to the reject box.

Accordingly, in the banknote deposit/withdrawal device 10, storing the storage section 11M with the information during storage expressing the conveyance state during storage of the banknotes in the temporary holding section 15 and comparing the conveyance state when feeding out banknotes from the temporary holding section 15 against the information during storage enables any difference between the conveyance states to be determined, based on which appropriate determination can be made as to whether to convey each banknote to the banknote storage boxes 17 or to the reject box 16. Namely, in the banknote deposit/withdrawal device 10, during the deposit storage processing, each banknote can be appropriately stored without passing the verification section 14, thereby enabling simpler conveyance paths than in the conventional banknote deposit/withdrawal device 810 (FIG. 32).

(11) Further, the medium processing device, in the above described (10), the reject switching section may be provided in the first conveyance section between the input/output section and the verification section, and in a case in which a conveyance state of the medium fed out from the temporary holding section differs from the conveyance state during storage and the first conveyance section is used to convey that individual medium to the reject box, the control section may use the verification section to re-verify the medium, and in a case in which the verification result of this time matches the verification results stored in the storage section, the control section may use the first conveyance section to convey the medium so as to return the medium toward the temporary holding section, and then may convey the medium either to the medium storage box or to the reject box according to the verification result stored in the storage section.

Accordingly, in the banknote deposit/withdrawal device 10, in cases in which a difference arises in the conveyance states of banknotes between storage in the temporary holding section 15 and feeding out from the temporary holding section 15, if, when conveying all of the banknotes subsequent to the difference arising to the reject box 16, a match is found between the result of re-verifying the respective banknotes and the information during counting stored during the deposit counting processing by the verification section 14, these banknotes are considered normal banknotes and are conveyed back in the opposite direction in the direction of the temporary holding section 15, and can be conveyed to the banknote storage boxes 17 and the like based on the stored verification results, thereby enabling the proportion of banknotes that are reused to be increased.

(12) Further, the medium processing device, in the above described (10), the temporary holding detection section may detect an inter-medium spacing and an angle of the medium with respect to a conveyance direction as a conveyance state of the medium.

The banknote deposit/withdrawal device 10 accordingly enables appropriate determination to be made as to whether or not the conveyance destination stored in the storage section 11M may be employed based on the spacing between the banknotes and the angles of the banknotes with respect to the conveyance direction.

(13) Further, the medium processing device, in the above described (1), the input/output section may further include: a container that contains the medium; a take-in port that takes the medium inside the container individually and passes the medium to the first conveyance section; a discharge port that is independent of the take-in port and that discharges the medium received from the first conveyance section into the container; a take-in conveyance path joined to the take-in port; a discharge conveyance path joined to the discharge port; and an input/output switching section that switches so as to connect the first conveyance section to either the take-in conveyance path or the discharge conveyance path.

Accordingly, the banknote deposit/withdrawal device 210 enables banknotes deposited to the container 12A to be taken in through the take-in port 212C, and passed to the conveyance section 13 through the take-in conveyance section 212D, the switching section 212E, and the deposit/withdrawal conveyance section 212F, and also enables banknotes for withdrawal received from the conveyance section 13 to be discharged into the container 12A from the discharge port 212H through the deposit/withdrawal conveyance section 212F, the switching section 212E, and the discharge conveyance section 212G.

(14) Further, the medium processing device, in the above described (13), the container may contain plural medium in a state arranged in a line; the take-in port may take in the medium positioned at a head of the line; and the discharge port may position the medium that has been discharged at a back end of the media arranged in a line.

Accordingly, in the banknote deposit/withdrawal device 210, due to discharging deposit reject banknotes into the container 12A from the discharge port 212H when deposit reject banknotes arise, the deposit reject banknotes can be positioned on the side farthest from the take-in port 212C out of the banknotes arranged in a line in the container 12A, and taken in last. A situation in which the deposit reject banknotes are discharged and taken in repeatedly, such that other banknotes cannot be taken in, to be pre-empted.

(15) Further, the medium processing device, in the above described (1), the verification section may include plural sensors disposed along a conveyance path of the medium, and the control section may acquire a verification result for the respective medium from the plural sensors of the verification section, decide a conveyance destination of the respective medium according to the verification result, and change conveyance processing of the respective medium according to a position where the respective medium was present inside the first conveyance section when the control section acquired the verification result and decided the conveyance destination.

Accordingly, in the banknote deposit/withdrawal device 10, for example during withdrawal processing, in cases in which the banknote control section 11 acquires the verification results from the verification section 14 and determines a banknote to be a reject banknote, and changes the conveyance destination to the reject box 16 when the banknote has already been conveyed to a position where it can no longer be conveyed to the reject box 16, the banknote can be conveyed to the reject box 16 by changing the conveyance processing.

(16) Further, the medium processing device, in the above described (15), the reject switching section may be provided in the first conveyance section between the input/output section and the verification section; and during dispensing processing to dispense the medium to outside, when conveying the medium fed out from the medium storage box to the input/output section through the second conveyance section, the temporary holding switching section, and the first conveyance section, the control section may switch the reject switching section based on a verification result of the verification section, such that a medium determined to be unsuitable for dispensing to the outside are conveyed to the reject box, and other mediums are conveyed to the input/output section.

Accordingly, in the banknote deposit/withdrawal device 10, during withdrawal processing, the banknote control section 11 switches the reject switching section 23 of the first conveyance section 21 based on the verification results, thereby enabling enables reject banknotes determined to be unsuitable for withdrawal to be conveyed to the reject box 16, and other normal banknotes to be conveyed to the deposit/withdrawal section 12.

(17) Further, the medium processing device, in the above described (1), the verification section may include a run sensor that detects a running state of the medium, and other sensors, and the run sensor may be disposed on a running path of the medium at a position that is farthest from the reject switching section.

Accordingly, in the banknote deposit/withdrawal device 10, during withdrawal processing, the amount of time taken from a banknote passing the run sensor 31 until the banknote reaches the reject switching section 23 can be set as long as possible, thereby enabling the conveyance path from the verification section 14 to the reject switching section 23 to be made shorter.

(18) Further, the medium processing device, in the above described (17), the control section may decide a conveyance destination of the medium based on a verification result of the medium by the run sensor and may switch the reject switching section so as to convey the medium either to the input/output section or to the reject box.

Accordingly, in the banknote deposit/withdrawal device 10, during withdrawal processing, a banknote conveyed from the far side of the reject switching section 23 is detected by the run sensor 31 first. This thereby enables the conveyance destination of the banknote to be decided by the banknote control section 11 based on the detection result, and enables the reject switching section 23 to be switched accordingly, before the banknote reaches the reject switching section 23.

(19) Further, the medium processing device, in the above described (17), at least some of the other sensors may be disposed at a position from which the medium reaches the reject switching section before a verification result of the medium being conveyed is obtained and sent to the control section, and before the control section switches the reject switching section based on the verification result.

Accordingly, in the banknote deposit/withdrawal device 10, during withdrawal processing, the running state, which may change every time a banknote is fed out from the banknote storage boxes 17 and the like, can be detected first by the run sensor 31. Moreover, disposing the authenticity sensor 33 and the like that have a low likelihood of detecting a counterfeit note during withdrawal at a position closer to the reject switching section 23 than the length of a short edge of a banknote enables the front-rear length of the first conveyance section 21 and the banknote deposit/withdrawal device 10 to be made as short as possible.

(20) Further, the medium processing device, in the above described (19), in cases in which the conveyance destination is changed based on the verification result obtained from at least some of the other sensors after deciding the conveyance destination based on the verification result of the medium by the run sensor and switching the reject switching section, the control section may stop the medium while it is being conveyed by the first conveyance section, and further conveys the medium in an opposite direction and returns the medium further to the verification section side than the reject switching section, before switching the reject switching section according to the changed conveyance destination and conveying the medium.

Accordingly, in the banknote deposit/withdrawal device 10, in cases in which a banknote has already passed the reject switching section 23, and has reached the conveyance path inside the front part 21A of the first conveyance section 21 or the conveyance path heading toward the take-in/discharge port 12C of the deposit/withdrawal section 12, conveyance of the banknote can be immediately stopped by the deposit/withdrawal section 12, and the banknote can be conveyed back in the opposite direction to the rear side of the verification section 14, and the conveyance path of the reject switching section 23 can be switched toward the reject box 16 side. This thereby enables the banknote to be conveyed to the reject box 16 without incorrectly discharging the banknote into the container 12A of the deposit/withdrawal section 12.

(21) Further, the medium processing device, in the above described (19), the at least some of the other sensors may be disposed between the reject switching section and the input/output section.

Accordingly, the banknote deposit/withdrawal device 310 enables the length of the overall device in the front-rear direction to be suppressed while conveying reject banknotes to the reject box 16 during withdrawal.

(22) Further, the medium processing device, in the above described (1), a main conveyance direction of the medium in the second conveyance section may be substantially parallel to a main conveyance direction of the medium in the first conveyance section.

The banknote deposit/withdrawal device 10 accordingly enables the conveyance path length to be shortened and configuration to be simplified, and enables a reduction in the number of components, even in cases in which the conveyance path is formed in a loop shape similarly to in the conventional banknote deposit/withdrawal device 810.

(23) Further, the medium processing device, in the above described (1), the medium storage box and the reject box may be disposed on the same side with respect to the first conveyance section and the second conveyance section, and may be disposed inside a robust casing that is more robust than other portions.

Accordingly, the banknote deposit/withdrawal device 10 may enable the safe casing 10S that protects the banknote storage boxes 17 and the reject box 16 in which a large quantity of banknotes are stored to be configured with a relatively small size. Namely, in comparison with the conventional banknote deposit/withdrawal device 810 (FIG. 32), in the banknote deposit/withdrawal device 10, the first conveyance section 21 and the second conveyance section 22 are disposed outside the safe casing 10S, thereby enabling the safe casing 10S to be configured with a small size. Moreover, in the banknote deposit/withdrawal device 10, there is no need to access the inside of the safe casing 10S when, for example, banknote blockages (jams) occur inside the conveyance section 13. This thereby enables the jammed banknotes to be removed even by a member of staff with a low security level who is not capable of accessing the inside of the safe casing 10S.

(24) Further, the medium processing device, in the above described (1), may further include: a counterfeit medium storage box that stores a counterfeit medium that are mediums verified as counterfeit by the verification section; and a counterfeit medium switching section that connects the counterfeit medium storage box to either the first conveyance section or the second conveyance section, wherein, in cases in which the medium has been verified as the counterfeit medium by the verification section, the control section may use the first conveyance section or the second conveyance section to convey the counterfeit medium to the counterfeit medium storage box.

Accordingly, the banknote deposit/withdrawal device 10 may enable normal banknotes and counterfeit notes to be stored in the temporary holding section 15 during the deposit counting processing, thereby enabling the normal banknotes to be stored in the banknote storage boxes 17, and the counterfeit notes to be stored in the counterfeit note box 18 through the second conveyance section 22 in the subsequent deposit storage processing.

(25) Further, the medium processing device, in the above described (1), the medium storage box and the reject box may each be attachable and detachable with respect to a casing of the medium processing device, and may be mutually interchangeable with regards to attachment to the casing of the medium processing device and with regards to conveyance of the medium.

Accordingly, The banknote deposit/withdrawal device 10 may enable the banknote storage boxes 17 and the reject box 16 to be respectively loaded into any slot in the safe casing 10S, thereby enabling various operation modes to be flexibly accommodated by changing the loading positions.

(26) Further, the medium processing device, in the above described (1), may further include a loading block in which plural medium storage boxes can be loaded in a state arranged in a line along a specific arrangement direction, wherein the first conveyance section, the temporary holding switching section, and the second conveyance section may form a conveyance path of the medium running along the arrangement direction.

Accordingly, the banknote deposit/withdrawal device 10 may enable the conveyance section to be configured simply, and enables the banknote conveyance path to be kept very short. This thereby may enable simplification of the device configuration, and may enable the amount of time required for transaction processing to be reduced.

(27) Further, the medium processing device, in the above described (1), may further include: a first connection medium storage box that stores the reusable medium; and a first switching section that connects between the verification section and the temporary holding switching section, that is connected to the first connection medium storage box, and that switches a conveyance path of the medium.

Accordingly, the banknote deposit/withdrawal device 10 may enable the first connection medium storage box to be connected to the first conveyance section even when the number of medium storage boxes that can be connected to the second conveyance section is limited due to constraints in the length of the second conveyance section. This thereby may enable the total number of the medium storage boxes together with the first connection medium storage box to be increased, and may enable the number of the media that can be stored to be increased.

(28) Furthermore, a medium transaction device includes: an input/output section that inputs/outputs a paper sheet shaped medium for transaction with a user; a first conveyance section, connected to the input/output section, that conveys the medium; a verification section, provided to the first conveyance section, that verifies the conveyed medium; a storage section that stores a verification result of the verification section; a temporary holding switching section, connected to the first conveyance section at the opposite side from the input/output section and with the verification section thereinbetween, that switches a conveyance path of the medium; a temporary holding section, connected to the first conveyance section through the temporary holding switching section, that stores the medium temporarily, and that feeds out the medium in the same sequence or in a reverse sequence to when the medium was stored; a second conveyance section, connected to either the temporary holding section or the first conveyance section through the temporary holding switching section, that conveys the medium; a medium storage box, connected to the second conveyance section, that stores reusable medium; a reject box, connected to either the first conveyance section or the second conveyance section through a reject switching section, that stores any reject medium that has been verified in the verification section as unsuitable for reuse; and a control section that, during an acceptance transaction to accept the medium from a user through the input/output section, uses the first conveyance section to convey the medium from the input/output section to the temporary holding section through the verification section, and stores in the storage section a verification result by the verification section for the respective medium, and according to the verification result stored in the storage section for each of the medium, feeds the medium out from the temporary holding section and conveys the medium to either the medium storage box or to the reject box.

Accordingly, in the ATM 1, during the deposit counting processing, banknotes taken in from the deposit/withdrawal section 12 are stored in sequence in the temporary holding section 15 while undergoing verification by the verification section 14, and the information during counting expressing the verification results is stored in the storage section 11M, after which, during deposit storage processing, the banknotes are fed out from the temporary holding section 15 in the reverse sequence to when being stored, and are conveyed to a conveyance destination based on the information during counting stored in the storage section 11M by the temporary holding switching section 20, the first conveyance section 21, and the second conveyance section 22, thereby enabling appropriate storage in the banknote storage boxes 17 or the reject box 16 without performing re-verification. Namely, in the ATM 1, the conveyance path of the conveyance section 13 is configured in a straight line shape rather than a loop shape, while employing a configuration capable of performing appropriate deposit counting processing. Accordingly, the ATM 1 may enable a simpler configuration than hitherto, may reduce size the number of components, and may also reduce the frequency of breakdowns and the amount of work required in maintenance operations.

### INDUSTRIAL APPLICABILITY

The present invention may be employed in an ATM that performs transaction processing relating to deposit and withdrawal of banknotes with a customer.

The disclosures of Japanese Patent Applications No. 2014-073492 and No. 2014-219730 are incorporated in their entirety by reference herein.

All cited documents, patent applications and technical standards mentioned in the present specification are incorporated by reference in the present specification to the same extent as if the individual cited document, patent application, or technical standard was specifically and individually indicated to be incorporated by reference.

1. A medium processing device comprising:
an input/output section that inputs or outputs a paper sheet shaped medium;
a first conveyance section, connected to the input/output section, that conveys the medium;
a verification section, provided to the first conveyance section, that verifies the conveyed medium;
a temporary holding switching section, connected to the first conveyance section at the opposite side from the input/output section and with the verification section thereinbetween, that switches a conveyance path of the medium;
a temporary holding section, connected to the first conveyance section through the temporary holding switching section, that stores the medium temporarily, and that feeds out the medium in the same sequence or in a reverse sequence to when the medium was stored;
a second conveyance section, connected to either the temporary holding section or the first conveyance section through the temporary holding switching section, that conveys the medium;
a medium storage box, connected to the second conveyance section, that stores reusable medium;
a reject box, connected to either the first conveyance section or the second conveyance section through a reject switching section, that stores any rejected medium that has been verified in the verification section as unsuitable for reuse; and
a control section that employs a verification result of the verification section to control a conveyance path of the medium configured by the first conveyance section, the temporary holding switching section, and the second conveyance section.

2. The medium processing device of claim 1, further comprising a storage section that stores a verification result of the verification section,
wherein, during acceptance processing to accept the medium from outside through the input/output section, the control section uses the first conveyance section to convey the medium from the input/output section to the temporary holding section through the verification section, and stores in the storage section verification results by the verification section for each of the respective medium, and according to the verification results stored in the storage section for the medium, feeds the medium out from the temporary holding section and conveys the medium to either the medium storage box or to the reject box.

3. The medium processing device of claim 2, wherein:
the second conveyance section includes at least a portion of the conveyance path of the medium as a conveyance path retention section that temporarily retains the medium; and
the control section controls the temporary holding switching section such that a reject medium that has been conveyed by the first conveyance section and determined in the verification section as medium unsuitable for acceptance into the device is conveyed to the second conveyance section and retained in the conveyance path retention section, and at least one part of other mediums are conveyed to and stored in the temporary holding section.

4. The medium processing device of claim 3, wherein:
the first conveyance section conveys the medium with an inter-medium spacing set to a specific conveyance spacing; and
when passing the reject medium from the first conveyance section to the second conveyance section through the temporary holding switching section, the control section reduces the inter-medium spacing to a retention spacing that is shorter than the conveyance spacing.

5. The medium processing device of claim 4, wherein, when passing the reject medium from the first conveyance section to the second conveyance section through the temporary holding switching section, the control section intermittently conveys the medium in the second conveyance section.

6-7. (canceled)

8. The medium processing device of claim 3, further comprising:
a counterfeit medium storage box that stores a counterfeit medium that is a medium verified as counterfeit by the verification section; and
a counterfeit medium switching section that connects the counterfeit medium storage box to the second conveyance section,
wherein, in cases in which the medium has been verified as the counterfeit medium by the verification section, the control section uses the first conveyance section to convey and store the counterfeit medium in the temporary holding section, and then uses the second conveyance section to convey the counterfeit medium to the counterfeit medium storage box.

9. The medium processing device of claim 2, wherein:
the temporary holding section includes a temporary holding detection section that detects a conveyance state of the medium; and
the control section controls a conveyance path of the medium according to a conveyance state at the time of storing the medium in the temporary holding section, and a conveyance state at the time of feeding out the medium from the temporary holding section.

10. The medium processing device of claim 9, wherein:
the storage section stores a detection result of the temporary holding detection section as a conveyance state during storage; and
in cases in which a conveyance state of the medium detected by the temporary holding detection section during feed-out from the temporary holding section differs from the conveyance state during storage being stored in the storage section, the control section conveys the medium and the following medium to the reject box.

11. The medium processing device of claim 10, wherein:
the reject switching section is provided in the first conveyance section between the input/output section and the verification section; and
in a case in which a conveyance state of the medium fed out from the temporary holding section differs from the conveyance state during storage and the first conveyance section is used to convey that individual medium to the reject box, the control section uses the verification section to re-verify the medium, and in a case in which the verification result of this time matches the verification results stored in the storage section, the control section uses the first conveyance section to convey the medium so as to return the medium toward the temporary holding section, and then conveys the medium either to the medium storage box or to the reject box according to the verification result stored in the storage section.

12. (canceled)

13. The medium processing device of claim 1, wherein the input/output section further includes:
a container that contains the medium;
a take-in port that takes the medium inside the container individually and passes the medium to the first conveyance section;
a discharge port that is independent of the take-in port and that discharges the medium received from the first conveyance section into the container;
a take-in conveyance path joined to the take-in port;
a discharge conveyance path joined to the discharge port; and
an input/output switching section that switches so as to connect the first conveyance section to either the take-in conveyance path or the discharge conveyance path.

14. (canceled)

15. The medium processing device of claim 1, wherein:
the verification section includes a plurality of sensors disposed along a conveyance path of the medium; and
the control section acquires a verification result for the respective medium from the plurality of sensors of the verification section, decides a conveyance destination of the respective medium according to the verification result, and changes conveyance processing of the respective medium according to a position where the respective medium was present inside the first conveyance section when the control section acquired the verification result and decided the conveyance destination.

16. The medium processing device of claim 15, wherein:
the reject switching section is provided in the first conveyance section between the input/output section and the verification section; and
during dispensing processing to dispense the medium to outside, when conveying the medium fed out from the medium storage box to the input/output section through the second conveyance section, the temporary holding switching section, and the first conveyance section, the control section switches the reject switching section based on a verification result of the verification section, such that a medium determined to be unsuitable for dispensing to the outside are conveyed to the reject box, and other mediums are conveyed to the input/output section.

17. The medium processing device of claim 1, wherein:
the verification section includes a run sensor that detects a running state of the medium, and other sensors, and
the run sensor is disposed on a running path of the medium at a position that is farthest from the reject switching section.

18. The medium processing device of claim 17, wherein the control section decides a conveyance destination of the medium based on a verification result of the medium by the run sensor and switches the reject switching section so as to convey the medium either to the input/output section or to the reject box.

19-21. (canceled)

22. The medium processing device of claim 1, wherein a main conveyance direction of the medium in the second conveyance section is substantially parallel to a main conveyance direction of the medium in the first conveyance section.

23. The medium processing device of claim 1, wherein the medium storage box and the reject box are disposed on the same side with respect to the first conveyance section and the second conveyance section, and are disposed inside a robust casing that is more robust than other portions.

24. The medium processing device of claim 1, further comprising:
a counterfeit medium storage box that stores a counterfeit medium that are mediums verified as counterfeit by the verification section; and
a counterfeit medium switching section that connects the counterfeit medium storage box to either the first conveyance section or the second conveyance section,
wherein, in cases in which the medium has been verified as the counterfeit medium by the verification section, the control section uses the first conveyance section or the second conveyance section to convey the counterfeit medium to the counterfeit medium storage box.

25. (canceled)

26. The medium processing device of claim 1, further comprising a loading block in which a plurality of the medium storage boxes can be loaded in a state arranged in a line along a specific arrangement direction,
wherein the first conveyance section, the temporary holding switching section, and the second conveyance section form a conveyance path of the medium running along the arrangement direction.

27. The medium processing device of claim 1, further comprising:
a first connection medium storage box that stores the reusable medium; and
a first switching section that connects between the verification section and the temporary holding switching section, that is connected to the first connection medium storage box, and that switches a conveyance path of the medium.

28. A medium transaction device comprising:
an input/output section that inputs/outputs a paper sheet shaped medium for transaction with a user;
a first conveyance section, connected to the input/output section, that conveys the medium;
a verification section, provided to the first conveyance section, that verifies the conveyed medium;
a storage section that stores a verification result of the verification section;
a temporary holding switching section, connected to the first conveyance section at the opposite side from the input/output section and with the verification section thereinbetween, that switches a conveyance path of the medium;
a temporary holding section, connected to the first conveyance section through the temporary holding switching section, that stores the medium temporarily, and that feeds out the medium in the same sequence or in a reverse sequence to when the medium was stored;
a second conveyance section, connected to either the temporary holding section or the first conveyance section through the temporary holding switching section, that conveys the medium;
a medium storage box, connected to the second conveyance section, that stores reusable medium;
a reject box, connected to either the first conveyance section or the second conveyance section through a reject switching section, that stores any reject medium that has been verified in the verification section as unsuitable for reuse; and
a control section that, during an acceptance transaction to accept the medium from a user through the input/output section, uses the first conveyance section to convey the medium from the input/output section to the temporary holding section through the verification section, and stores in the storage section a verification result by the verification section for the respective medium, and according to the verification result stored in the storage section for each of the medium, feeds the medium out from the temporary holding section and conveys the medium to either the medium storage box or to the reject box.
